(19) United States
(12) Patent Application Publication
(10) Pub. No.: US 2020/0165490 A1
(43) Pub. Date: May 28, 2020

(54) EPOXY/THIOL RESIN COMPOSITIONS, METHODS, AND TAPES

(71) Applicant: 3M INNOVATIVE PROPERTIES COMPANY, St. Paul, MN (US)

(72) Inventors: Matthew J. Kryger, Hudson, WI (US); Michael A. Kropp, Cottage Grove, MN (US); Thomas B. Galush, Roseville, MN (US); Daniel R. Fronek, Woodbury, MN (US)

(21) Appl. No.: 16/621,275

(22) PCT Filed: May 30, 2018
(86) PCT No.: PCT/IB2018/053856

§ 371 Date: Dec. 11, 2019

Related U.S. Application Data
(60) Provisional application No. 62/518,284, filed on Jun. 12, 2017.

(51) Int. Cl. C09J 7/25; C09J 163/00; C08G 59/24; C08G 59/66; C09J 7/38

(52) U.S. Cl. CPC C09J 7/25; C09J 163/00; C08G 59/245; C09J 2483/00; C09J 7/38; C09J 2483/006; C09J 2463/001; C08G 59/66

(57) ABSTRACT

Curable epoxy/thiol resin compositions, methods of curing, methods of bonding substrates, and tapes including the cured polymeric material, wherein the curable epoxy/thiol resin composition includes: an epoxy resin component comprising an epoxy resin having at least two epoxide groups per molecule; a thiol component comprising a polythiol compound having at least two primary thiol groups; a silane-functionalized adhesion promoter; a nitrogen-containing catalyst for curing the epoxy resin; and optionally a cure inhibitor.

### BACKGROUND

Silicone is a high-performance elastomeric material. It has a wide variety of uses and is often used as seals or gaskets due to its flexibility and ability to be compressed between two surfaces. Other uses include flexible medical devices and tubing, prosthetics, surgical implants, and for special effects in the film industry. Due to its high temperature resistance, it is becoming popular in kitchen items for bakeware and cookware. One challenge with silicones is that in its solid, cured state, it is normally very flexible and very hard to bond with adhesives.

Silicones exhibit a very low surface energy so materials inherently do not adhere well to silicones. Additionally, almost all silicones have plasticizers that migrate to the surface. There are few ways to improve the surface of silicone to improve the ability of adhesives to bond to its surface. Some solvents can be used to remove plasticizers or processing lubricants from the silicone. Surface treatments, such as corona or plasma processes, can help prepare the surface for improved adhesion, but even with such treatments further improvement in bonding strength is desired as there are few adhesives that show good adhesion to surface-treated silicones. Some adhesives that show good adhesion to silicones are often slow curing, and can demonstrate plasticizer migration that deteriorates performance of the silicone. There exists a need for improved materials and methods to bond silicone materials to enable their use.

### SUMMARY

The present disclosure provides a curable epoxy/thiol resin composition. Upon being cured, the curable epoxy/thiol system provides a cured polymeric material (e.g., an adhesive polymeric material) that has good adhesion to silicone surfaces, and in certain embodiments, good flexibility.

In one embodiment, the composition includes: an epoxy resin component including an epoxy resin having at least two epoxide groups per molecule; a thiol component including a polythiol compound having at least two primary thiol groups; a silane-functionalized adhesion promoter; a nitrogen-containing catalyst for curing the epoxy resin; and an optional cure inhibitor.

In certain embodiments, the silane-functionalized adhesion promoter has the following general Formula (II): (X)ₘ—Y—(Si(R²)₃)ₙ, wherein: X is an epoxy or thiol group, Y is an aliphatic group, m and n are independently 1-3, and each R² is independently an alkoxy group.

In certain embodiments, the epoxy resin component and/or the thiol component are selected to provide a cured polymeric material that does not crack according to the Cylindrical Mandrel Bend Test and/or has a tensile elongation of at least 100% according to the Tensile Modulus and Elongation Test.

The curable epoxy/thiol resin composition can be a one-part or a two-part composition. In certain embodiments, a “one-part” composition includes the epoxy resin component, the thiol component, the nitrogen-containing catalyst, the silane-functionalized adhesion promoter, the cure inhibitor, and any additional optional additives (e.g., fillers, toughening agents, diluents, and other adhesion promoters) in admixture. In certain embodiments, a “two-part” composition includes a base and an accelerator. The base includes the epoxy resin component and the silane-functionalized adhesion promoter. The accelerator includes the thiol component and the nitrogen-containing catalyst. Any additional optional additives (e.g., fillers, toughening agents, diluents, and other adhesion promoters) can be admixed into either the base or the accelerator.

Also provided are methods of curing a curable, epoxy/thiol resin composition. In one embodiment, the method includes: providing a curable, one-part epoxy/thiol resin composition as described herein; and heating the curable, one-part epoxy/thiol resin composition to a temperature of at least 50° C. In another embodiment, the method includes: providing a curable, two-part epoxy/thiol resin composition as described herein; combining the base and the accelerator to form a base/accelerator mixture; and providing conditions sufficient to cure the base/accelerator mixture (e.g., a temperature of at least room temperature).

The present disclosure also provides articles such as tapes. In one embodiment, an article includes: a film that includes a cured polymeric material formed from a curable epoxy/thiol resin composition described herein. Such article may have a pressure sensitive adhesive layer disposed on at least one major surface of the film, thereby forming a tape. In another embodiment, a tape includes: a silicone backing, a pressure sensitive silicone adhesive, and a tie layer disposed there between, wherein the tie layer includes a cured polymeric material prepared from a curable epoxy/thiol resin composition described herein.

Also provided are methods of bonding two substrates. In one embodiment, the method includes: providing two substrates, at least one of which is a silicone substrate having a treated surface; providing a curable epoxy/thiol resin composition described herein (which may be in one or two parts); applying the curable epoxy/thiol resin composition to at least one surface of at least one of the substrates; contacting a surface of each of the two substrates, thereby forming contacting surfaces, such that the curable epoxy/thiol resin composition is disposed between the contacting surfaces; and providing conditions effective to cure the curable epoxy/thiol resin composition.

The term “aliphatic” refers to C1-C40, suitably C1-C30, straight or branched chain alkenyl, alkyl, or alkynyl which may or may not be interrupted or substituted by one or more heteroatoms such as O, N, or S.

The term “cycloaliphatic” refers to cyclized aliphatic C3-C30, suitably C3-C20, groups and includes those interrupted by one or more heteroatoms such as O, N, or S. Examples include cyclopentyl, cyclohexyl, cycloheptyl, and the like.

The term “alkyl” refers to a monovalent group that is a radical of an alkane and includes straight-chain, branched, cyclic, and bicyclic alkyl groups, and combinations thereof, including both unsubstituted and substituted alkyl groups. Unless otherwise indicated, the alkyl groups typically contain from 1 to 30 carbon atoms. In some embodiments, the alkyl groups contain 1 to 20 carbon atoms, 1 to 10 carbon atoms, 1 to 6 carbon atoms, 1 to 4 carbon atoms, or 1 to 3 carbon atoms. Examples of “alkyl” groups include, but are not limited to, methyl, ethyl, n-propyl, n-butyl, n-pentyl, isobutyl, t-butyl, isopropyl, n-octyl, n-heptyl, ethylhexyl, cyclopentyl, cyclohexyl, cycloheptyl, adamantyl, norbornyl, and the like.

The term “alkenyl group” means an unsaturated, linear or branched hydrocarbon group with one or more carbon-carbon double bonds, such as a vinyl group.

The term “alkynyl group” means an unsaturated, linear or branched hydrocarbon group with one or more carbon-carbon triple bonds.

The term “alkoxy” refers to refers to a monovalent group having an oxy group bonded directly to an alkyl group.

The term “alkylene” refers to a divalent group that is a radical of an alkane and includes groups that are linear, branched, cyclic, bicyclic, or a combination thereof. Unless otherwise indicated, the alkylene group typically has 1 to 30 carbon atoms. In some embodiments, the alkylene group has 1 to 20 carbon atoms, 1 to 10 carbon atoms, 1 to 6 carbon atoms, or 1 to 4 carbon atoms. Examples of “alkylene” groups include methylene, ethylene, propylene, 1,4-butylene, 1,4-cyclohexylene, and 1,4-cyclohexyldimethylene.

The term “aromatic” refers to C3-C40, suitably C3-C30, aromatic rings including both carboxyclic aromatic groups as well as heterocyclic aromatic groups containing one or more of the heteroatoms, O, N, or S, and fused ring systems containing one or more of these aromatic groups fused together.

The term “aryl” refers to a monovalent group that is aromatic and, optionally, carbocyclic. The aryl has at least one aromatic ring. Any additional rings can be unsaturated, partially saturated, saturated, or aromatic. Optionally, the aromatic ring can have one or more additional carbocyclic rings that are fused to the aromatic ring. Unless otherwise indicated, the aryl groups typically contain from 6 to 30 carbon atoms. In some embodiments, the aryl groups contain 6 to 20, 6 to 18, 6 to 16, 6 to 12, or 6 to 10 carbon atoms. Examples of an aryl group include phenyl, naphthyl, biphenyl, phenanthryl, and anthracyl.

The term “arylene” refers to a divalent group that is aromatic and, optionally, carbocyclic. The arylene has at least one aromatic ring. Optionally, the aromatic ring can have one or more additional carbocyclic rings that are fused to the aromatic ring. Any additional rings can be unsaturated, partially saturated, or saturated. Unless otherwise specified, arylene groups often have 6 to 20 carbon atoms, 6 to 18 carbon atoms, 6 to 16 carbon atoms, 6 to 12 carbon atoms, or 6 to 10 carbon atoms.

The term “aralkyl” refers to a monovalent group that is an alkyl group substituted with an aryl group (e.g., as in a benzyl group). The term “alkaryl” refers to a monovalent group that is an aryl substituted with an alkyl group (e.g., as in a tolyl group). Unless otherwise indicated, for both groups, the alkyl portion often has 1 to 10 carbon atoms, 1 to 6 carbon atoms, or 1 to 4 carbon atoms and an aryl portion often has 6 to 20 carbon atoms, 6 to 18 carbon atoms, 6 to 16 carbon atoms, 6 to 12 carbon atoms, or 6 to 10 carbon atoms.

Herein, the term “comprises” and variations thereof do not have a limiting meaning where these terms appear in the description and claims. Such terms will be understood to imply the inclusion of a stated step or element or group of steps or elements but not the exclusion of any other step or element or group of steps or elements. By “consisting of” is meant including, and limited to, whatever follows the phrase “consisting of.” Thus, the phrase “consisting of” indicates that the listed elements are required or mandatory, and that no other elements may be present. By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they materially affect the activity or action of the listed elements. Any of the elements or combinations of elements that are recited in this specification in open-ended language (e.g., comprise and derivatives thereof), are considered to additionally be recited in closed-ended language (e.g., consist and derivatives thereof) and in partially closed-ended language (e.g., consist essentially, and derivatives thereof).

The words “preferred” and “preferably” refer to embodiments of the disclosure that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the disclosure.

In this application, terms such as “a,” “an,” and “the” are not intended to refer to only a singular entity, but include the general class of which a specific example may be used for illustration. The terms “a,” “an,” and “the” are used interchangeably with the term “at least one.” The phrases “at least one of” and “comprises at least one of” followed by a list refers to any one of the items in the list and any combination of two or more items in the list.

As used herein, the term “or” is generally employed in its usual sense including “and/or” unless the content clearly dictates otherwise.

The term “and/or” means one or all of the listed elements or a combination of any two or more of the listed elements.

Also herein, all numbers are assumed to be modified by the term “about” and in certain embodiments, preferably, by the term “exactly.” As used herein in connection with a measured quantity, the term “about” refers to that variation in the measured quantity as would be expected by the skilled artisan making the measurement and exercising a level of care commensurate with the objective of the measurement and the precision of the measuring equipment used. Herein, “up to” a number (e.g., up to 50) includes the number (e.g., 50).

Also herein, the recitations of numerical ranges by endpoints include all numbers subsumed within that range as well as the endpoints (e.g., 1 to 5 includes 1, 1.5, 2, 2.75, 3, 3.80, 4, 5, etc.).

As used herein, the term “room temperature” refers to a temperature of 22° C. to 25° C.

The term “in the range” or “within a range” (and similar statements) includes the endpoints of the stated range.

Reference throughout this specification to “one embodiment,” “an embodiment,” “certain embodiments,” or “some embodiments,” etc., means that a particular feature, configuration, composition, or characteristic described in connection with the embodiment is included in at least one embodiment of the invention. Thus, the appearances of such phrases in various places throughout this specification are not necessarily referring to the same embodiment of the invention. Furthermore, the particular features, configurations, compositions, or characteristics may be combined in any suitable manner in one or more embodiments.

The above summary of the present disclosure is not intended to describe each disclosed embodiment or every implementation of the present invention. The description that follows more particularly exemplifies illustrative embodiments. In several places throughout the application, guidance is provided through lists of examples, which examples may be used in various combinations. In each instance, the recited list serves only as a representative group and should not be interpreted as an exclusive list. Thus, the scope of the present disclosure should not be limited to the specific illustrative structures described herein, but rather extends at least to the structures described by the language of the claims, and the equivalents of those structures. Any of the elements that are positively recited in this specification as alternatives may be explicitly included in the claims or excluded from the claims, in any combination as desired. Although various theories and possible mechanisms may have been discussed herein, in no event should such discussions serve to limit the claimable subject matter.

### BRIEF DESCRIPTION OF THE DRAWINGS

FIG. 1 is a representation of an exemplary tape that includes a backing (of a cured polymeric material formed from a curable epoxy/thiol resin composition of the present disclosure) having a major surface on which is disposed a layer of an adhesive. The layers are not necessarily to scale.

FIG. 2 is a representation of an exemplary tape that includes a backing on which is disposed a tie layer (of a cured polymeric material made from a curable epoxy/thiol resin composition of the present disclosure), and a layer of an adhesive disposed on the tie layer. The layers are not necessarily to scale.

FIG. 3 is a representation of an exemplary tape that includes a backing having a layer of a cured polymeric material (made from a curable epoxy/thiol resin composition of the present disclosure) on one side of the backing, and an adhesive on the opposite side of the backing. The layers are not necessarily to scale.

### DETAILED DESCRIPTION OF ILLUSTRATIVE EMBODIMENTS

The present disclosure provides a curable epoxy/thiol resin composition. Upon being cured, the curable epoxy/thiol system provides a cured polymeric material (e.g., an adhesive polymeric material) that has good adhesion to silicone surfaces. In certain embodiments, the cured polymeric material is also flexible. Such cured polymeric material can be used in articles such as tapes, in particular silicone tapes.

Certain epoxy/thiol resin compositions show excellent adhesion to silicone substrates due to the incorporation of silane-functionalized adhesion promoters. In certain embodiments, some surface preparation (e.g., plasma, flame, or corona treatment) may be used to enhance adhesion. For example, the epoxy/thiol resin compositions show high adhesiveness to corona-treated silicone surfaces even months after exposure to the environment. In certain embodiments, cured polymeric materials formed from curable epoxy/thiol resin compositions described herein have high elongation and do not detract from the flexibility of the silicone substrate.

In one embodiment, a curable composition includes: an epoxy resin component including an epoxy resin having at least two epoxide groups per molecule; a thiol component including a polythiol compound having at least two primary thiol groups; a nitrogen-containing catalyst for curing the epoxy resin; a silane-functionalized adhesion promoter; and optionally a cure inhibitor. The cure inhibitor can be a Lewis acid or a weak Bronsted acid.

The curable epoxy/thiol resin composition can be a one-part or a two-part composition.

In certain embodiments, a curable “one-part” epoxy/thiol resin composition includes all components, including the thiol curing agent, the nitrogen-containing catalyst, the silane-functionalized adhesion promoter, the cure inhibitor, and any optional additives (e.g., fillers, toughening agents, diluents, and other adhesion promoters) are admixed with the epoxy resin. The cure inhibitor can be a Lewis acid or a weak Bronsted acid. During formulation of a one-part composition, the cure inhibitor is added to the other components of the composition prior to the addition of the nitrogen-containing catalyst.

When formulated in one part, the curable one-part epoxy/thiol resin compositions of the present disclosure possess excellent storage stability at room temperature, particularly with respect to viscosity maintenance over time. In certain embodiments, the curable one-part epoxy/thiol resin compositions are stable at room temperature for a period of at least 2 weeks, at least 4 weeks, or at least 2 months. In this context, “stable” means that the epoxy/thiol composition remains in a curable form.

Additionally, the curable one-part epoxy/thiol resin compositions are curable at low temperatures. In certain embodiments, the curable one-part epoxy/thiol resin compositions are curable at a temperature of at least 50° C. In certain embodiments, the curable one-part epoxy/thiol resin compositions are curable at a temperature of up to 80° C. In certain embodiments, the curable one-part epoxy/thiol compositions are curable at a temperature of 60-65° C.

In certain embodiments, the curable epoxy/thiol resin composition is a “two-part” composition that includes a base and an accelerator. The base includes the epoxy resin component and the silane-functionalized adhesion promoter. The accelerator includes the thiol component and the nitrogen-containing catalyst. Any additional optional additives (e.g., fillers, toughening agents, diluents, and other adhesion promoters) can be admixed into either the base or the accelerator. Typically, cure inhibitors are not necessary in two-part compositions because the base and accelerant remain separate until mixing at the time of application.

When formulated in two parts, the curable two-part epoxy/thiol resin compositions of the present disclosure are stable at room temperature. In certain embodiments, the curable two-part epoxy/thiol resin compositions are stable at room temperature for a period of at least 2 weeks, at least 4 weeks, or at least 2 months. In this context, “stable” means that the epoxy/thiol composition remains in a curable form. Additionally, upon combining the two parts, the curable two-part epoxy/thiol resin compositions cure at room temperature.

Thus, curable epoxy/thiol resin compositions of the present disclosure are suitable for use in temperature-sensitive bonding applications, particularly in the electronics industry, e.g., in cell phone assembly and bonding of plastic and metal parts. They may also be used in a variety of other applications, such as in the automotive and aerospace industries for parts bonding.

In certain embodiments, selection of the epoxy resin component and the thiol component can provide a cured material that is flexible. At least one of such components is flexible. By this it is meant that the epoxy resin component and/or the thiol component (preferably, both the epoxy resin component and the thiol component) are selected to provide a cured polymeric material that is flexible, i.e., a cured polymeric material that does not crack according to the Cylindrical Mandrel Bend Test and/or has a tensile elongation of at least 100% according to the Tensile Modulus and Elongation Test. In certain embodiments, both the epoxy resin component and the thiol component are selected to provide a cured polymeric material that does not crack according to the Cylindrical Mandrel Bend Test and has a tensile elongation of at least 100% according to the Tensile Modulus and Elongation Test. Using such combination of components can preferably provide a cured polymeric material having a flexibility that approaches the elongation of silicone.

Thus, a cured polymeric material prepared from a curable epoxy/thiol resin composition can function as a flexible coating, such as a coating on a silicone. For example, the cured polymeric material can function as a barrier coat for pressure sensitive silicone adhesives. In particular, the cured polymeric material can be effective as a tie layer between a silicone backing layer and a pressure sensitive silicone adhesive in a silicone tape (e.g., silicone masking tape). The cured polymeric material shows excellent adhesion to a silicone substrate, as well as good barrier properties towards plasticizer migration from the pressure sensitive silicone adhesive.

The present disclosure also provides articles such as tapes, wherein a cured polymeric material formed from a curable epoxy/thiol resin composition described herein forms a backing on which is disposed an adhesive. Alternatively, a cured polymeric material formed from a curable epoxy/thiol resin composition described herein forms a tie layer between a distinct backing and an adhesive.

In one embodiment, a tape includes: a film that includes a cured polymeric material formed from a curable epoxy/thiol resin composition described herein; and a pressure sensitive adhesive layer disposed on at least one major surface of the film. In certain embodiments, the film forms the backing of the tape. In certain embodiments, the film forms a layer on a separate backing. That is, in certain embodiments, the film is disposed on a backing and forms a tie layer between the backing and the pressure sensitive adhesive layer. In certain embodiments, the backing includes a silicone backing. In certain embodiments, the pressure sensitive adhesive includes a pressure sensitive silicone adhesive.

In certain embodiments, the present disclosure provides a silicone tape that includes a silicone backing, a pressure sensitive silicone adhesive, and a tie layer disposed therebetween. The tie layer includes a cured polymeric material prepared from a curable epoxy/thiol resin composition of the present disclosure.

Also provided are methods of bonding two substrates.

In one embodiment, the method includes: providing two substrates, at least one of which is a surface-treated silicone substrate (i.e., a silicone substrate having a treated surface); providing a curable epoxy/thiol resin composition described herein (which may be in one or two parts); applying the curable epoxy/thiol resin composition to at least one surface of at least one of the substrates; contacting a surface of each of the two substrates (thereby forming contacting surfaces) such that the curable epoxy/thiol resin composition is disposed between the contacting surfaces and is in contact with the treated surface of the silicone substrate; and providing conditions effective to cure the curable epoxy/thiol resin composition.

In one embodiment, the curable epoxy/thiol resin composition is a curable epoxy/thiol resin composition in one part; and the curing step of the method includes heating the curable, one-part epoxy/thiol resin composition to a temperature of at least 50° C.

In another embodiment, the curable epoxy/thiol resin composition is a curable epoxy/thiol resin composition in two parts that includes a base and an accelerator; and the applying step of the method includes combining the base and the accelerator to form a mixture and applying the mixture to at least one surface of at least one of the substrates; and the curing step of the method includes allowing the base and accelerator mixture to react at room temperature.

### Epoxy Resin Component

The epoxy resin component included in the curable epoxy/polythiol resin compositions contains an epoxy resin that has at least two epoxy functional groups (i.e., oxirane groups) per molecule. As used herein, the term oxirane group refers to the following divalent group.

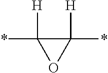 [SMILES: *C1OC1*]

The asterisks denote a site of attachment of the oxirane group to another group. If an oxirane group is at the terminal position of the epoxy resin, the oxirane group is typically bonded to a hydrogen atom.

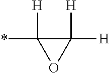 [SMILES: *C1CO1]

This terminal oxirane group is often part of a glycidyl group.

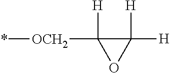

The epoxy resin includes a resin with at least two oxirane groups per molecule. For example, an epoxy compound can have 2 to 10, 2 to 6, or 2 to 4 oxirane groups per molecule. The oxirane groups are usually part of a glycidyl group.

Epoxy resins can include a single material or mixture of materials (e.g., monomeric, oligomeric, or polymeric compounds) selected to provide desired viscosity characteristics before curing and to provide desired mechanical properties after curing. If the epoxy resin includes a mixture of materials, at least one of the epoxy resins in the mixture is usually selected to have at least two oxirane groups per molecule. For example, a first epoxy resin in the mixture can have two to four or more oxirane groups and a second epoxy resin in the mixture can have one to four oxirane groups. In some of these examples, the first epoxy resin is a first glycidyl ether with two to four glycidyl groups and the second epoxy resin is a second glycidyl ether with one to four glycidyl groups.

The portion of the epoxy resin that is not an oxirane group (i.e., an epoxy resin compound minus the oxirane groups) can be aromatic, aliphatic, or a combination thereof and can be linear, branched, cyclic, or a combination thereof. The aromatic and aliphatic portions of the epoxy resin can include heteroatoms or other groups that are not reactive with the oxirane groups. That is, the epoxy resin can include halo groups, oxy groups (such as in an ether linkage group), thio groups (such as in a thio ether linkage group), carbonyl groups, carbonyloxy groups, carbonylimino groups, phosphono groups, sulfono groups, nitro groups, nitrile groups, and the like. The epoxy resin can also be a silicone-based material such as a polydiorganosiloxane-based material.

Although the epoxy resin can have any suitable molecular weight, the weight average molecular weight is usually at least 100 grams/mole, at least 150 grams/mole, at least 175 grams/mole, at least 200 grams/mole, at least 250 grams/mole, or at least 300 grams/mole. The weight average molecular weight can be up to 50,000 grams/mole or even higher for polymeric epoxy resins. The weight average molecular weight is often up to 40,000 grams/mole, up to 20,000 grams/mole, up to 10,000 grams/mole, up to 5,000 grams/mole, up to 3,000 grams/mole, or up to 1,000 grams/mole. For example, the weight average molecular weight can be in the range of 100 to 50,000 grams/mole, in the range of 100 to 20,000 grams/mole, in the range of 100 to 10,000 grams/mole, in the range of 100 to 5,000 grams/mole, in the range of 200 to 5,000 grams/mole, in the range of 100 to 2,000 grams/mole, in the range of 200 to 2,000 grams/mole, in the range of 100 to 1,000 grams/mole, or in the range of 200 to 1,000 grams/mole.

Suitable epoxy resins are typically liquid at room temperature; however, solid epoxy resins that can be dissolved in one of the other components of the composition, such as a liquid epoxy resin, can be used if desired. In most embodiments, the epoxy resin is a glycidyl ether. Exemplary glycidyl ethers can be of Formula (I):

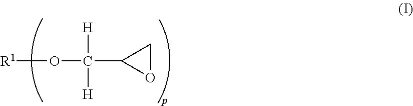

wherein R¹ is a polyvalent group that is aromatic, aliphatic, or a combination thereof. In Formula (I), R¹ can be linear, branched, cyclic, or a combination thereof, and can optionally include halo groups, oxy groups, thio groups, carbonyl groups, carbonyloxy groups, carbonylimino groups, phosphono groups, sulfono groups, nitro groups, nitrile groups, and the like. Although the variable p in Formula (I) can be any suitable integer greater than or equal to 2, p is often an integer in the range of 2 to 10, in the range of 2 to 6, or in the range of 2 to 4.

In some embodiments, the epoxy resin is a polyglycidyl ether of a polyhydric phenol, such as polyglycidyl ethers of bisphenol A, bisphenol F, bisphenol AD, catechol, and resorcinol. In some embodiments, the epoxy resin is a reaction product of a polyhydric alcohol with epichlorohydrin. Exemplary polyhydric alcohols include butanediol, polyethylene glycol, and glycerin. In some embodiments, the epoxy resin is an epoxidised (poly)olefinic resin, epoxidised phenolic novolac resin, epoxidised cresol novolac resin, and cycloaliphatic epoxy resin. In some embodiments, the epoxy resin is a glycidyl ether ester, such as that which can be obtained by reacting a hydroxycarboxylic acid with epichlorohydrin, or a polyglycidyl ester, such as that which can be obtained by reacting a polycarboxylic acid with epichlorohydrin. In some embodiments, the epoxy resin is a urethane-modified epoxy resin. Various combinations of two or more epoxy resins can be used if desired.

In some exemplary epoxy resins of Formula (I), the variable p is equal to 2 (i.e., the epoxy resin is a diglycidyl ether) and R¹ includes an alkylene (i.e., an alkylene is a divalent radical of an alkane and can be referred to as an alkane-diyl), heteroalkylene (i.e., a heteroalkylene is a divalent radical of a heteroalkane and can be referred to as a heteroalkane-diyl), arylene (i.e., a divalent radical of an arene compound), or combination thereof. Suitable alkylene groups often have 1 to 20 carbon atoms, 1 to 12 carbon atoms, 1 to 8 carbon atoms, or 1 to 4 carbon atoms. Suitable heteroalkylene groups often have 2 to 50 carbon atoms, 2 to 40 carbon atoms, 2 to 30 carbon atoms, 2 to 20 carbon atoms, 2 to 10 carbon atoms, or 2 to 6 carbon atoms with 1 to 10 heteroatoms, 1 to 6 heteroatoms, or 1 to 4 heteroatoms. The heteroatoms in the heteroalkylene can be selected from oxy, thio, or —NH— groups but are often oxy groups. Suitable arylene groups often have 6 to 18 carbon atoms or 6 to 12 carbon atoms. For example, the arylene can be phenylene, fluorenylene, or biphenylene. Group R¹ can further optionally include halo groups, oxy groups, thio groups, carbonyl groups, carbonyloxy groups, carbonylimino groups, phosphono groups, sulfono groups, nitro groups, nitrile groups, and the like. The variable p is usually an integer in the range of 2 to 4.

Some epoxy resins of Formula (I) are diglycidyl ethers where R¹ includes (a) an arylene group or (b) an arylene group in combination with an alkylene, heteroalkylene, or both. Group R¹ can further include optional groups such as halo groups, oxy groups, thio groups, carbonyl groups, carbonyloxy groups, carbonylimino groups, phosphono groups, sulfono groups, nitro groups, nitrile groups, and the like. These epoxy resins can be prepared, for example, by reacting an aromatic compound having at least two hydroxyl groups with an excess of epichlorohydrin. Examples of useful aromatic compounds having at least two hydroxyl groups include, but are not limited to, resorcinol, catechol, hydroquinone, p,p′-dihydroxydibenzyl, p,p′-dihydroxyphenylsulfone, p,p′-dihydroxybenzophenone, 2,2′-dihydroxyphenyl sulfone, p,p′-dihydroxybenzophenone, and 9,9-(4-hydroxyphenol)fluorene. Still other examples include the 2,2′, 2,3′, 2,4′, 3,3′, 3,4′, and 4,4′ isomers of dihydroxydiphenylmethane, dihydroxydiphenyldimethylmethane, dihydroxydiphenylethylmethylmethane, dihydroxydiphenylmethylpropylmethane, dihydroxydiphenylethylphenylmethane, dihydroxydiphenylpropylenphenylmethane, dihydroxydiphenylbutylphenylmethane, dihydroxydiphenyltolylethane, dihydroxydiphenyltolylmethylmethane, dihydroxydiphenyldicyclohexylmethane, and dihydroxydiphenylcyclohexane.

Some commercially available diglycidyl ether epoxy resins of Formula (I) are derived from bisphenol A (i.e., bisphenol A is 4,4′-dihydroxydiphenylmethane). Examples include, but are not limited to, those available under the tradename EPON (e.g., EPON 1510, EPON 1310, EPON 828, EPON 872, EPON 1001, EPON 1004, and EPON 2004) from Momentive Specialty Chemicals, Inc. (Columbus, Ohio), those available under the tradename DER (e.g., DER 331, DER 332, DER 336, and DER 439) from Olin Epoxy Co. (St. Louis, Mo.), and those available under the tradename EPICLON (e.g., EPICLON 850) from Dainippon Ink and Chemicals, Inc. (Parsippany, N.J.). Other commercially available diglycidyl ether epoxy resins are derived from bisphenol F (i.e., bisphenol F is 2,2′-dihydroxydiphenylmethane). Examples include, but are not limited to, those available under the tradename DER (e.g., DER 334) from Olin Epoxy Co. (St. Louis, Mo.), those available under the tradename EPICLON (e.g., EPICLON 830) from Dainippon Ink and Chemicals, Inc. (Parsippany, N.J.), and those available under the tradename ARALDITE (e.g., ARALDITE 281) from Huntsman Corporation (The Woodlands, Tex.).

Other epoxy resins of Formula (I) are diglycidyl ethers of a poly(alkylene oxide) diol. These epoxy resins also can be referred to as diglycidyl ethers of a poly(alkylene glycol) diol. The variable p is equal to 2 and R¹ is a heteroalkylene having oxygen heteroatoms. The poly(alkylene glycol) portion can be a copolymer or homopolymer and often includes alkylene units having 1 to 4 carbon atoms. Examples include, but are not limited to, diglycidyl ethers of poly(ethylene oxide) diol, diglycidyl ethers of poly(propylene oxide) diol, and diglycidyl ethers of poly(tetramethylene oxide) diol. Epoxy resins of this type are commercially available from Polysciences, Inc. (Warrington, Pa.) such as those derived from a poly(ethylene oxide) diol or from a poly(propylene oxide) diol having a weight average molecular weight of 400 grams/mole, about 600 grams/mole, or about 1000 grams/mole.

Still other epoxy resins of Formula (I) are diglycidyl ethers of an alkane diol (R¹ is an alkylene and the variable p is equal to 2). Examples include a diglycidyl ether of 1,4-dimethanol cyclohexyl, diglycidyl ether of 1,4-butanediol, and a diglycidyl ether of the cycloaliphatic diol formed from a hydrogenated bisphenol A such as those commercially available under the tradename EPONEX (e.g., EPONEX 1510) from Hexion Specialty Chemicals, Inc. (Columbus, Ohio) and under the tradename EPALLOY (e.g., EPALLOY 5001) from CVC Thermoset Specialties (Moorestown, N.J.).

For some applications, the epoxy resins chosen for use in the curable coating compositions are novolac epoxy resins, which are glycidyl ethers of phenolic novolac resins. These resins can be prepared, for example, by reaction of phenols with an excess of formaldehyde in the presence of an acidic catalyst to produce the phenolic novolac resin. Novolac epoxy resins are then prepared by reacting the phenolic novolac resin with epichlorihydrin in the presence of sodium hydroxide. The resulting novolac epoxy resins typically have more than two oxirane groups and can be used to produce cured coating compositions with a high crosslinking density. The use of novolac epoxy resins can be particularly desirable in applications where corrosion resistance, water resistance, chemical resistance, or a combination thereof is desired. One such novolac epoxy resin is poly[(phenyl glycidyl ether)-co-formaldehyde]. Other suitable novolac resins are commercially available under the tradename ARALDITE (e.g., ARALDITE GY289, ARALDITE EPN 1183, ARALDITE EP 1179, ARALDITE EPN 1139, and ARALDITE EPN 1138) from Huntsman Corporation (The Woodlands, Tex.), under the tradename EPALLOY (e.g., EPALLOY 8230) from CVC Thermoset Specialties (Moorestown, N.J.), and under the tradename DEN (e.g., DEN 424 and DEN 431) from Olin Epoxy Co. (St. Louis, Mo.).

Yet other epoxy resins include silicone resins with at least two glycidyl groups and flame retardant epoxy resins with at least two glycidyl groups (e.g., a brominated bisphenol-type epoxy resin having at least two glycidyl groups such as that commercially available from Dow Chemical Co. (Midland, Mich.) under the tradename DER 580).

In certain embodiments, preferred epoxy resin components are flexible. By this it is meant that the epoxy resin component, when combined with a thiol component (whether flexible or not) and cured, provides a cured polymer material that does not crack according to the Cylindrical Mandrel Bend Test and/or has a tensile elongation of at least 100% according to the Tensile Modulus and Elongation Test. Such flexibility can be provided by a flexible epoxy compound and/or a reactive monofunctional diluent. Flexible epoxy compounds include those based on linear or cyclic aliphatic backbone structures. Also, flexibility of an epoxy compound can be increased by increasing side chain length and/or molecular weight between reactive sites.

Epoxy compounds based on linear or cyclic aliphatic structures provide flexibility and include those available under the tradenames HELOXY 71, EPON 872, and EPONEX 1510, all from Momentive Specialty Chemicals, Inc. (Columbus, Ohio). These include diglycidyl ethers of polyethers, examples of which include those available under the tradenames DER 732 and DER 736 from Olin Epoxy Co. (St. Louis, Mo.), HELOXY 84 from Momentive Specialty Chemicals, Inc., and GRILONIT F 713 from EMS-Griltech (Domat/Ems, Switzerland). Epoxies based on cashew nut oil or other natural oils also offer flexibility, examples of which include those available under the tradenames NC513 and NC 514 from Cardolite (Monmouth Junction, N.J.) and HELOXY 505 from Momentive Specialty Chemicals, Inc. Epoxies based on diglycidyl ethers of Bisphenol A, which have pendant aliphatic groups, also can offer flexibility, an example of which is an alkyl-functionalized diglycidyl ether of Bisphenol A that is available under the tradename ARALDITE PY 4122 from Huntsman (The Woodlands, Tex.). Other examples of flexible epoxies include ethoxylated or propoxylated bisphenol A diglycidyl epoxy derivatives, examples of which are available under the tradenames RIKARESIN BPO-20E and RIKARESIN BEO-60E from New Japan Chemical Co. Ltd. (Osaka, Japan) and EP 4000S and EP 4000L from Adeka Corp. (Tokyo, Japan). Various combinations of such flexible epoxies can be used in the epoxy resin component if desired.

The epoxy resin component is often a mixture of materials. For example, the epoxy resins can be selected to be a mixture that provides the desired viscosity or flow characteristics prior to curing. For example, within the epoxy resin may be reactive diluents that include monofunctional or certain multifunctional epoxy resins. The reactive diluent should have a viscosity which is lower than that of the epoxy resin having at least two epoxy groups. Ordinarily, the reactive diluent should have a viscosity less than 250 mPa·s. The reactive diluent tends to lower the viscosity of the epoxy/thiol resin composition and often has either a branched backbone that is saturated or a cyclic backbone that is saturated or unsaturated. Preferred reactive diluents have only one functional group (i.e., oxirane group) such as various monoglycidyl ethers.

Some exemplary monofunctional epoxy resins include, but are not limited to, those with an alkyl group having 6 to 28 carbon atoms, such as (C6-C28)alkyl glycidyl ethers, (C6-C28)fatty acid glycidyl esters, (C6-C28)alkylphenol glycidyl ethers, and combinations thereof. In the event a monofunctional epoxy resin is the reactive diluent, such monofunctional epoxy resin should be employed in an amount of up to 50 parts based on the total of the epoxy resin component. An example of such diluent is a glycidyl ester of versatic acid 10, a synthetic saturated monocarboxylic acid of highly branched C10 isomers, available under the tradename CARDURA E10P GLYCIDYL ESTER from Hexion Inc. (Columbus, Ohio). Such monofunctional diluents in the epoxy resin component can be used to increase the flexibility of the cured material produced from a curable epoxy/thiol resin composition of the present disclosure.

In some embodiments, the curable epoxy/thiol resin compositions typically include at least 20 weight percent (wt-%), at least 25 wt-%, at least 30 wt-%, at least 35 wt-%, at least 40 wt-%, or at least 45 wt-%, epoxy resin component, based on a total weight of the curable epoxy/thiol resin composition. If lower levels are used, the cured composition may not contain enough polymeric material (e.g., epoxy resin) to provide desired coating characteristics. In some embodiments, the curable epoxy/thiol resin compositions include up to 80 wt-%, up to 75 wt-%, or up to 70 wt-%, epoxy resin component, based on a total weight of the curable epoxy/thiol resin composition.

### Thiol Component

A thiol is an organosulfur compound that contains a carbon-bonded sulfhydryl or mercapto (—C—SH) group. Suitable polythiols are selected from a wide variety of compounds that have two or more thiol groups per molecule, and that function as curatives for epoxy resins.

Examples of suitable polythiols include trimethylolpropane tris(beta-mercaptopropionate), trimethylolpropane tris(thioglycolate), pentaerythritol tetrakis(thioglycolate), pentaerythritol tetrakis(beta-mercaptopropionate), dipentaerythritol poly(beta-mercaptopropionate), ethylene glycol bis(beta-mercaptopropionate), a (C1-C12)alkyl polythiol (e.g., butane-1,4-dithiol and hexane-1,6-dithiol), a (C6-C12)aromatic polythiol (e.g., p-xylenedithiol and 1,3,5-tris (mercaptomethyl) benzene). Combinations of polythiols can be used if desired.

In certain embodiments, preferred thiol components are those that are flexible. By this it is meant that the thiol component, when combined with an epoxy resin component (whether flexible or not) and cured, provides a cured polymer material that does not crack according to the Cylindrical Mandrel Bend Test and/or has a tensile elongation of at least 100% according to the Tensile Modulus and Elongation Test. Such flexibility can be provided by a flexible epoxy compound and/or a reactive monofunctional diluent. Thiol compounds based on linear or cyclic aliphatic structures provide flexibility. Also, flexibility of a thiol can be increased by increasing side chain length and/or molecular weight between reactive sites. Examples of flexible thiols include Thiocure ETTMP 700, Thiocure ETTMP 1300, and Thiocure PCL4MP, all available from Bruno Bock (Marschacht, Germany). Various combinations of such flexible thiols can be used in the thiol component if desired.

In some embodiments, the curable epoxy/thiol resin compositions typically include at least 25 wt-%, at least 30 wt-%, or at least 35 wt-%, thiol component, based on a total weight of the curable epoxy/thiol resin composition. In some embodiments, the curable epoxy/thiol resin compositions include up to 70 wt-%, up to 65 wt-%, up to 60 wt-%, up to 55 wt-%, up to 50 wt-%, up to 45 wt-%, or up to 40 wt-%, thiol component, based on a total weight of the curable epoxy/thiol resin composition. Various combinations of two or more polythiols can be used if desired.

In some embodiments, the ratio of the epoxy resin component to the thiol component in the curable epoxy/thiol resin compositions of the present disclosure is from 0.5:1 to 1.5:1, or from 0.75:1 to 1.3:1 (epoxy:thiol equivalents).

Systems containing epoxy resins and polythiols suitable for use in the present disclosure are disclosed in U.S. Pat. No. 5,430,112 (Sakata et al.).

### Silane-Functionalized Adhesion Promoter

Silane-functionalized adhesion promoters provide bonding to a silicone-containing material, for example, between a bulk adhesive and a silicone-containing surface. Not being bound by theory, it is theorized that the surface of a silicone polymer contains unreacted silanol functionality that can covalently bond with the silicone atoms of the functionalized silane adhesion promoter, leading to greater adhesion of the cured polymeric material (e.g., epoxy adhesive) to the surface of the silicone.

Suitable silane-functionalized adhesion promoters have the following general Formula (II):

(X)ₘ—Y—(Si(R²)₃)ₙ

wherein X is an epoxy or thiol group, Y is an aliphatic group (typically, a (C2-C6)aliphatic group), m and n are independently 1-3 (typically, each of m and n is 1), and each R² is independently an alkoxy group (typically, —OMe or —OEt group). Various combinations of silane-functionalized adhesion promoters can be used if desired.

Examples of adhesion promoters of Formula (II) include, for example, 3-glycidoxypropyltriethoxysilane 5,6-epoxyhexyltriethoxysilane, 2-(3,4-epoxycyclohexyl)ethyltriethoxysilane, mercaptopropyltriethoxysilane, s-(octanoyl)mercaptopropyltriethoxysilane, hydroxy(polyethyleneoxy)propyltriethoxysilane, and a combination thereof.

In some embodiments, the curable epoxy/thiol resin compositions include at least 0.1 part, or at least 0.5 part, silane-functionalized adhesion promoter, based on 100 parts of the combined weights of the epoxy resin and thiol components. In some embodiments, the curable epoxy/thiol resin compositions include up to 5 parts, or up to 2 parts, based on 100 parts of the combined weights of the epoxy resin and thiol components. Various combinations of two or more silane-functionalized adhesion promoters can be used if desired.

### Nitrogen-Containing Catalyst

The epoxy/thiol resin compositions of the present disclosure include at least one nitrogen-containing catalyst. Such catalysts are typically of the heat activated class. In certain embodiments, the nitrogen-containing catalyst is capable of activation at temperatures at or above 50° C. to effect the thermal curing of the epoxy resin.

Suitable nitrogen-containing catalysts are typically solid at room temperature, and not soluble in the other components of the epoxy/thiol resin compositions of the present disclosure. In certain embodiments, the nitrogen-containing catalysts are in particle form having a particle size (i.e., the largest dimension of the particles, such as the diameter of a sphere) of at least 100 micrometers (i.e., microns).

As used herein, the term “nitrogen-containing catalyst” refers to any nitrogen-containing compound that catalyzes the curing of the epoxy resin. The term does not imply or suggest a certain mechanism or reaction for curing. The nitrogen-containing catalyst can directly react with the oxirane ring of the epoxy resin, can catalyze or accelerate the reaction of the polythiol compound with the epoxy resin, or can catalyze or accelerate the self-polymerization of the epoxy resin.

In certain embodiments, the nitrogen-containing catalysts are amine-containing catalysts. Some amine-containing catalysts have at least two groups of formula —NR³H, wherein R³ is selected from hydrogen, alkyl, aryl, alkaryl, or aralkyl. Suitable alkyl groups often have 1 to 12 carbon atoms, 1 to 8 carbon atoms, 1 to 6 carbon atoms, or 1 to 4 carbon atoms. The alkyl group can be cyclic, branched, linear, or a combination thereof. Suitable aryl groups usually have 6 to 12 carbon atom such as a phenyl or biphenyl group. Suitable alkylaryl groups can include the same aryl and alkyl groups discussed above.

The nitrogen-containing catalyst minus the at least two amino groups (i.e., the portion of the catalyst that is not an amino group) can be any suitable aromatic group, aliphatic group, or combination thereof.

Exemplary nitrogen-containing catalysts for use herein include a reaction product of phthalic anhydride and an aliphatic polyamine, more particularly a reaction product of approximately equimolar proportions of phthalic acid and diethylamine triamine, as described in British Patent 1,121,196 (Ciba Geigy AG). A catalyst of this type is available commercially from Ciba Geigy AG under the tradename CIBA HT 9506.

Yet another type of nitrogen-containing catalyst is a reaction product of: (i) a polyfunctional epoxy compound; (ii) an imidazole compound, such as 2-ethyl-4-methylimidazole; and (iii) phthalic anhydride. The polyfunctional epoxy compound may be a compound having two or more epoxy groups in the molecule as described in U.S. Pat. No. 4,546,155 (Hirose et al.). A catalyst of this type is commercially available from Ajinomoto Co. Inc. (Tokyo, Japan) under the tradename AJICURE PN-23, which is believed to be an adduct of EPON 828 (bisphenol type epoxy resin epoxy equivalent 184-194, commercially available from Hexion Specialty Chemicals, Inc. (Columbus, Ohio)), 2-ethyl-4-methylimidazole, and phthalic anhydride.

Other suitable nitrogen-containing catalysts include the reaction product of a compound having one or more isocyanate groups in its molecule with a compound having at least one primary or secondary amino group in its molecule. Additional nitrogen-containing catalysts include 2-heptadeoylimidazole, 2-phenyl-4,5-dihydroxymethylimidazole, 2-phenyl-4-methyl-5-hydroxymethylimidazole, 2-phenyl-4-benzyl-5-hydroxymethylimidazole, 2,4-diamino-8-2-methylimidazolyl-(1)-ethyl-5-triazine, or a combination thereof, as well as products of triazine with isocyanuric acid, succinohydrazide, adipohydrazide, isophtholohydrazide, o-oxybenzohydrazide, salicylohydrazide, or a combination thereof.

Nitrogen-containing catalysts are commercially available from sources such as Ajinomoto Co. Inc. (Tokyo, Japan) under the tradenames AMICURE MY-24, AMICURE GG-216 and AMICURE ATU CARBAMATE, from Hexion Specialty Chemicals, Inc. (Columbus, Ohio) under the tradename EPIKURE P-101, from T&K Toka (Chikumazawa, Miyoshi-Machi, Iruma-Gun, Saitama, Japan) under the tradenames FXR-1020, FXR-1081, and FXR-1121, from Shikoku (Marugame, Kagawa Prefecture, Japan) under the tradenames CUREDUCT P-2070 and P-2080, from Air Products and Chemicals, Inc. (Allentown, Pa.) under the tradenames ANCAMINE 2441 and 2442, from A&C Catalysts, Inc. (Linden, N.J.) under the tradenames TECHNICURE LC80 and LC100, and from Asahi Kasei Kogyo, K.K. (Japan) under the tradename NOVACURE HX-372.

Other suitable nitrogen-containing catalysts are those described in U.S. Pat. No. 5,077,376 (Dooley et al.) and U.S. Pat. No. 5,430,112 (Sakata et al.) referred to as “amine adduct latent accelerators.” Other exemplary nitrogen-containing catalysts are described, for example, in British Patent 1,121,196 (Ciba Geigy AG), European Patent Application No. 138465A (Ajinomoto Co.), and European Patent Application No. 193068A (Asahi Chemical).

In embodiments of two-part epoxy/thiol resin compositions, a variety of nitrogen-containing compounds, such as amines, can be used as catalysts. In some embodiments, the amine catalyst can be an imidazole, an imidazole-salt, an imidazoline, or a combination thereof. Aromatic tertiary amines may also be used as a catalyst, including those having the structure of Formula (III):

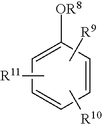

wherein: R⁸ is hydrogen or an alkyl group; R⁹, R¹⁰, and R¹¹ are, independently, hydrogen or CHNR¹²R¹³, wherein at least one of R⁹, R¹⁰, and R¹¹ is CHNR¹²R¹³; and R¹² and R¹³ are, independently, alkyl groups. In some embodiments of Formula (III), the alkyl groups of R⁸, R¹², and/or R¹³ are methyl or ethyl groups. One exemplary curative is tris-2,4,6-(dimethylaminomethyl)phenol, commercially available under the tradename ANCAMINE K54 from Evonik Industries (Essen, Germany). A second, more reactive, exemplary curative is 1,8-diazabicyclo(5.4.0)unde-7-ene (DBU) commercially available from MilliporeSigma (St. Louis, Mo.).

In some embodiments, the curable epoxy/thiol resin compositions typically include at least 1 part, at least 2 parts, at least 3 parts, at least 4 parts, or at least 5 parts, of a nitrogen-containing catalyst, per 100 parts (by weight) of the epoxy resin component. In some embodiments, the curable epoxy/thiol resin compositions typically include up to 45 parts, up to 40 parts, up to 35 parts, up to 30 parts, up to 25 parts, or up to 20 parts, of a nitrogen-containing catalyst, per 100 parts (by weight) of the epoxy resin component. Various combinations of two or more nitrogen-containing catalysts can be used if desired.

### Optional Cure Inhibitor

In embodiments of one-part epoxy/thiol resin compositions, an inhibitor is often necessary to obtain a reasonable shelf life/workability life at room temperature. The inhibitor typically retards the activity of the nitrogen-containing catalyst so that it does not proceed at an appreciable rate at room temperature. Although a cure inhibitor could be used in a two-part epoxy/thiol resin composition, it is not necessary.

Such cure inhibitors can be Lewis acids or weak Bronsted acids (i.e., Bronsted acids having a pH of 3 or higher), or a combination thereof. Such cure inhibitor is soluble in the epoxy/thiol resin composition.

In this context, a cure inhibitor that is “soluble in the epoxy/thiol resin composition” (i.e., a “soluble” cure inhibitor) refers to a compound which, when incorporated in an epoxy/thiol resin composition in an amount of 5 wt-%, produces an epoxy/thiol resin composition with at least 80% clarity and/or at least 80% transmission, as evaluated according to the Stabilizer Solubility Test in the Examples Section. In certain embodiments, the clarity of a curable epoxy/thiol resin composition that includes 5 wt-% of a “soluble” cure inhibitor is at least 85%, at least 90%, or at least 95%. In certain embodiments, the transmission of a curable epoxy/thiol resin composition that includes 5 wt-% of a “soluble” cure inhibitor is at least 85%, or at least 90%.

Such soluble cure inhibitors function as stabilizers of the nitrogen-containing catalyst. Desirably, the nitrogen-containing catalyst is stabilized against curing the epoxy resin at room temperature for a period of at least 2 weeks, at least 4 weeks, or at least 2 months.

Examples of Lewis acids include borate esters, such as that available under the tradename CUREZOL L-07N from Shikoku (Kagawa, Japan), as well as CaNO₃ and MnNO₃ available from MilliporeSigma (St. Louis, Mo.). Various combinations of Lewis acids can be used if desired.

Examples of weak Bronsted acids include barbituric acid derivatives, 1,3-cyclohexanedione, and 2,2-dimethyl-1,3-dioxane-4,6-dione from MilliporeSigma (St. Louis, Mo.). Various combinations of weak Bronsted acids can be used if desired.

Herein, barbituric acid “derivatives” include those barbituric acid compounds substituted at one or more of the 1, 3, and/or 5 N positions, or at the 1 and/or 3 N positions and optionally at the 5 N position, with an aliphatic, cycloaliphatic, or aromatic group. In certain embodiments,

the barbituric acid derivatives include those of Formula (IV):

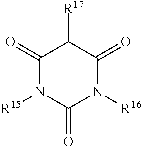

wherein one or more of the R¹⁵, R¹⁶, and R¹⁷ groups are represented by hydrogen, an aliphatic group, a cycloaliphatic group, or an aromatic group (e.g., phenyl), optionally further substituted in any position with one or more of (C1-C4)alkyl, —OH, halide (F, Br, Cl, I), phenyl, (C1-C4)alkylphenyl, (C1-C4)alkenylphenyl, nitro, or —OR¹⁸ where R¹⁸ is phenyl, a carboxylic group, a carbonyl group, or an aromatic group and R¹⁸ is optionally substituted with (C1-C4)alkyl, —OH, or halide; and further wherein at least one of the R¹⁵, R¹⁶, and R¹⁷ groups is not hydrogen. In certain embodiments, at least two of the R¹⁵, R¹⁶, and R¹⁷ groups are not hydrogen.

Examples of suitable barbituric acid derivatives include 1-benzyl-5-phenylbarbituric acid, 1-cycloheyl-5-ethylbarbituric acid (available from Chemische Fabrik Berg, Bitterfeld-Wolfen, Germany), 1,3-dimethylbarbituric acid (available from Alfa Aesar, Tewksbury, Mass.), and combinations thereof.

U.S. Pat. No. 6,653,371 (Burns et al.) teaches that a substantially insoluble solid organic acid is required for epoxy/thiol resin compositions to stabilize the composition. Surprisingly, it was found that the use of a soluble organic acid, in particular, a barbituric acid derivative that is functionalized to make it more soluble, results in better stabilization of the epoxy/thiol resin composition than the use of substantially insoluble organic acids. Also, U.S. Pat. No. 6,653,371 (Burns et al.) teaches that stabilizer effectiveness is directly affected by particle size of the stabilizing component added into the system. A benefit of using soluble barbituric acid derivatives as stabilizers is that the initial particle size does not alter stabilizer performance, at least because the stabilizer is fully dissolved throughout the curable epoxy/thiol resin compositions.

A soluble cure inhibitor is used in an epoxy/thiol resin composition in an amount that allows the epoxy/thiol resin composition to remain curable for at least 72 hours at room temperature such that there is no viscosity increase (e.g., no doubling in viscosity). Typically, this is an amount of at least 0.01 wt-%, based on the total weight of the curable epoxy/thiol resin composition.

The greater the amount of a soluble cure inhibitor used in an epoxy/thiol resin composition, generally the longer the shelf life of the curable epoxy/thiol resin composition. The greater the amount of a cure inhibitor used in an epoxy/thiol resin composition, generally the longer the time required to cure and/or the higher the temperature required to cure the curable epoxy/thiol resin composition. Thus, depending on the use of the curable composition, there is a balance between shelf life and cure time/temperature. Typically, for a reasonable shelf life, cure time, and cure temperature, the amount of soluble cure inhibitor used is up to 1 wt-%, or up to 0.5 wt-%.

### Optional Additives in the Curable Composition

In addition to the epoxy resin component, the thiol component, the silane-functionalized adhesion promoter, the nitrogen-containing catalyst, and the optional cure inhibitor, the curable composition can include other various optional additives. One such optional additive is a toughening agent. Toughening agents can be added to provide desired overlap shear, peel resistance, and impact strength. Useful toughening agents are polymeric materials that may react with the epoxy resin and that may be cross-linked. Suitable toughening agents include polymeric compounds having both a rubbery phase and a glassy phase or compounds which are capable of forming, with the epoxide resin, both a rubbery phase and a glassy phase on curing. Polymers useful as toughening agents are preferably selected to inhibit cracking of the cured epoxy composition.

Some polymeric toughening agents that have both a rubbery phase and a thermoplastic phase are acrylic core-shell polymers wherein the core is an acrylic copolymer having a glass transition temperature below 0° C. Such core polymers may include polybutyl acrylate, polyisooctyl acrylate, polybutadiene-polystyrene in a shell comprised of an acrylic polymer having a glass transition temperature above 25° C., such as polymethylmethacrylate. Commercially available core-shell polymers include those available as a dry powder under the tradenames ACRYLOID KM 323, ACRYLOID KM 330, and PARALOID BTA 731, from Dow Chemical Co. (Midland, Mich.), and KANE ACE B-564 from Kaneka Corporation (Osaka, Japan). These core-shell polymers may also be available as a predispersed blend with a diglycidyl ether of bisphenol A at, for example, a ratio of 12 to 37 parts by weight of the core-shell polymer and are available under the tradenames KANE ACE (e.g., KANE ACE MX 157, KANE ACE MX 257, and KANE ACE MX 125) from Kaneka Corporation (Japan).

Another class of polymeric toughening agents that are capable of forming, with the epoxide group-containing material, a rubbery phase on curing, are carboxyl-terminated butadiene acrylonitrile compounds. Commercially available carboxyl-terminated butadiene acrylonitrile compounds include those available under the tradenames HYCAR (e.g., HYCAR 1300X8, HYCAR 1300X13, and HYCAR 1300X17) from Lubrizol Advanced Materials, Inc. (Cleveland, Ohio) and under the tradename PARALOID (e.g., PARALOID EXL-2650) from Dow Chemical (Midland, Mich.).

Other polymeric toughening agents are graft polymers, which have both a rubbery phase and a thermoplastic phase, such as those disclosed in U.S. Pat. No. 3,496,250 (Czerwinski). These graft polymers have a rubbery backbone having grafted thereto thermoplastic polymer segments. Examples of such graft polymers include, for example, (meth)acrylate-butadiene-styrene, and acrylonitrile/butadiene-styrene polymers. The rubbery backbone is preferably prepared so as to constitute from 95 wt-% to 40 wt-% of the total graft polymer, so that the polymerized thermoplastic portion constitutes from 5 wt-% to 60 wt-% of the graft polymer.

Still other polymeric toughening agents are polyether sulfones such as those commercially available from BASF (Florham Park, N.J.) under the tradename ULTRASON (e.g., ULTRASON E 2020 P SR MICRO).

The curable composition can additionally contain a non-reactive plasticizer to modify rheological properties. Commercially available plasticizers include those available under the tradename BENZOFLEX 131 from Eastman Chemical (Kingsport, Tenn.), JAYFLEX DINA available from ExxonMobil Chemical (Houston, Tex.), and PLASTOMOLL (e.g., diisononyl adipate) from BASF (Florham Park, N.J.).

The curable composition optionally contains a flow control agent or thickener, to provide the desired rheological characteristics to the composition. Suitable flow control agents include fumed silica, such as treated fumed silica, available under the tradename CAB-O-SIL TS 720, and untreated fumed silica available under the tradename CAB-O-SIL M5, from Cabot Corp. (Alpharetta, Ga.).

In some embodiments, the curable composition optimally contains adhesion promoters other than the silane adhesion promoter to enhance the bond to the substrate. The specific type of adhesion promoter may vary depending upon the composition of the surface to which it will be adhered. Adhesion promoters that have been found to be particularly useful for surfaces coated with ionic type lubricants used to facilitate the drawing of metal stock during processing include, for example, dihydric phenolic compounds such as catechol and thiodiphenol.

The curable composition optionally may also contain one or more conventional additives such as fillers (e.g., aluminum powder, carbon black, glass bubbles, talc, clay, calcium carbonate, barium sulfate, titanium dioxide, silica such as fused silica, silicates, glass beads, and mica), pigments, flexibilizers, reactive diluents, non-reactive diluents, fire retardants, antistatic materials, thermally and/or electrically conductive particles, and expanding agents including, for example, chemical blowing agents such as azodicarbonamide or expandable polymeric microspheres containing a hydrocarbon liquid, such as those sold under the tradename EXPANCEL by Expancel Inc. (Duluth, Ga.). Particulate fillers can be in the form of flakes, rods, spheres, and the like. Additives are typically added in amounts to produce the desired effect in the resulting adhesive.

The amount and type of such additives may be selected by one skilled in the art, depending on the intended end use of the composition.

### Substrate

The present disclosure provides articles such as tapes and methods of bonding two substrates.

A representative article includes a film that includes a cured polymeric material formed from the curable epoxy/thiol resin composition of the present disclosure. This film may be free-standing or it may be disposed on a surface of a substrate. In certain embodiments, a pressure sensitive adhesive layer may be disposed on at least one major surface of the film. In certain embodiments, the film is disposed on a surface of a substrate (i.e., a first major surface), and a pressure sensitive adhesive is disposed on a second major surface of the substrate opposite the first major surface.

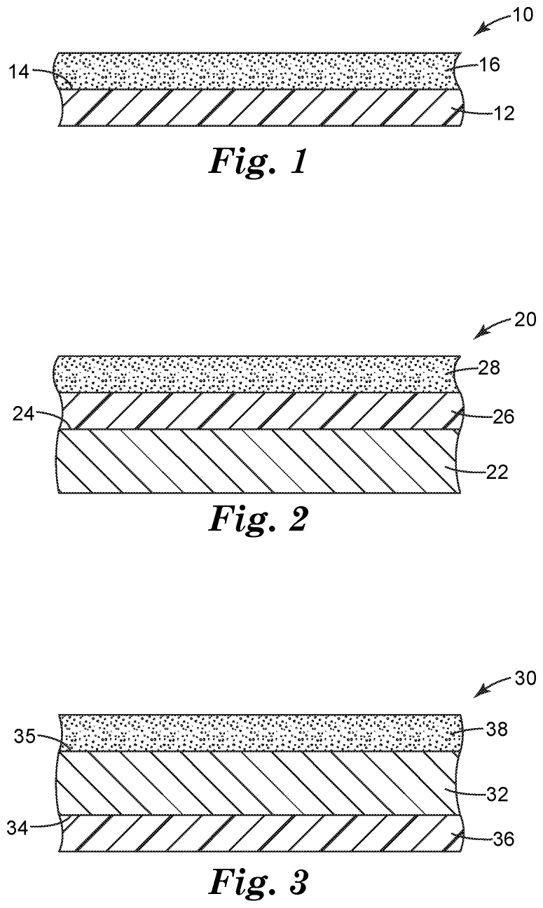

In one embodiment, the article is a tape, wherein a cured polymeric material formed from a curable epoxy/thiol resin composition described herein forms a backing on which is disposed an adhesive (FIG. 1), or it may form a tie layer between a separate and distinct backing and an adhesive (FIG. 2).

As shown in FIG. 1, a tape 10 is provided that includes a backing 12 of a cured polymeric material formed from a curable epoxy/thiol resin composition of the present disclosure, having a major surface 14 on which is disposed a layer of an adhesive 16 (e.g., a pressure sensitive adhesive). A curable epoxy/thiol resin composition can be formed into a backing (i.e., backing layer) by coating a curable epoxy/thiol resin composition onto a release liner, curing the material to form a solid film, and then removing it from the release liner, resulting in a free-standing backing layer/film. Alternatively, the curable composition can be coated between two release liners, cured, and then both release liners can be removed, resulting in a free-standing backing layer/film.

As shown in FIG. 2, a tape 20 is provided that includes a backing 22 having a major surface 24 (e.g., a corona- or plasma-treated surface of a backing) on which is disposed a tie layer 26 that includes a cured polymeric material made from a curable epoxy/thiol resin composition of the present disclosure, and a layer of an adhesive 28 (e.g., a pressure sensitive adhesive) disposed on the tie layer 26.

Alternatively, as shown in FIG. 3, a tape 30 can include a backing 32 having a first major surface 34 and a second (opposite) major surface 35. Disposed on the first major surface 34 is a layer 36 that includes a cured polymeric material made from a curable epoxy/thiol resin composition of the present disclosure. Disposed on the second major surface 35 is a layer of an adhesive 38 (e.g., a pressure sensitive adhesive) d. A curable epoxy/thiol resin composition can be coated onto a variety of flexible and inflexible backing materials using conventional coating techniques to produce epoxy/thiol-coated backings.

In certain embodiments, a backing layer (whether made of the curable epoxy/thiol resin composition or other material, particularly a silicone material) has a thickness of at least 2 mils (approximately 51 micrometers), at least 15 mils (approximately 380 micrometers), or at least 25 mils (635 micrometers). In certain embodiments, the backing layer has a thickness of up to up to 150 mils (approximately 3810 micrometers), up to 80 mils (approximately 2032 micrometers), or up to 50 mils (approximately 1070 micrometers).

In a bonding method, two substrates (i.e., bondable substrates), at least one of which is a silicone substrate, can be bonded together with a cured polymeric material formed from a curable epoxy/thiol resin composition described herein. A curable epoxy/thiol resin composition can be coated onto a variety of flexible and inflexible bondable substrates using conventional coating techniques to produce epoxy/thiol-coated substrates. The bondable substrates may be made of the same or different materials.

Suitable backings for tapes or bondable substrates can be made from a wide variety of materials, particularly flexible materials conventionally utilized as tape backings, optical films, or other flexible or inflexible materials.

In certain embodiments, a suitable backing or bondable substrate includes a flexible material conventionally used as a tape backing. Examples include, but are not limited to, plastic films such as a polyolefin (including polypropylene (e.g., biaxially oriented polypropylene, isotactic polypropylene) and polyethylene), polyvinyl chloride, polyester (e.g., polyethylene terephthalate, polybutylene terephthalate), polyimide, polycarbonate, polycaprolactam, polymethyl(meth)acrylate (PMMA), polystyrene, cellulose acetate, cellulose triacetate, and ethyl cellulose. Foamed materials (e.g., polyacrylic, polyethylene, polyurethane, neoprene) may also be used. In some embodiments, a suitable backing or bondable substrate may be made of a bio-based material such as polylactic acid (PLA) and other polylactides. Various combinations of such materials may be used.

In certain embodiments, a suitable backing or bondable substrate includes a fibrous material. For example, a suitable backing or bondable substrate can be made of nonwoven materials such as spunbond nonwovens, melt blown nonwovens, carded webs, air-laid nonwovens, needle-punched nonwovens, spunlace nonwovens, and the like, or suitable combinations thereof. In certain embodiments, a suitable backing or bondable substrate may be prepared of woven fabric formed of threads of synthetic or natural materials. The fibers of such nonwovens and wovens can be made from natural fibers and/or synthetic polymer fibers. Exemplary synthetic polymer fibers include those made of polyethylene, polypropylene, polyester, a polyamide such as nylon, polylactic acid, and combinations thereof. Exemplary natural fibers include those made of cellulose, hemp, bamboo, cotton, and combinations thereof.

In certain embodiments, a suitable backing or bondable substrate may also be formed of metals (e.g., metal foils), metalized polymer films, or ceramics (e.g., ceramic sheet materials).

Commercially available backing materials include, for example, HOSTAPHAN 3SAB primed polyester film (available from Mitsubishi Polyester Film Inc. (Greer, S.C.)); Kraft paper (available from Monadnock Paper, Inc.); cellophane (available from Flexel Corp.); spun-bond poly(ethylene) and poly(propylene), such as TYVEK and TYPAR (available from DuPont, Inc.); and porous films obtained from poly(ethylene) and poly(propylene), such as TESLIN (available from PPG Industries, Inc.), and CELLGUARD (available from Hoechst-Celanese).

In certain embodiments, the backing or bondable substrate includes a high consistency silicone elastomer (i.e., a silicone rubber or silicone rubber elastomer). A high consistency silicone elastomer (e.g., silicone rubber) is a common term used in the silicone rubber industry. Herein, a “silicone backing” or a “silicone substrate” refers to a backing or substrate that includes silicone at least at its surface, although silicone is typically included throughout the entire backing or substrate.

Suitable polymers used in silicone elastomers are of the following general structure:

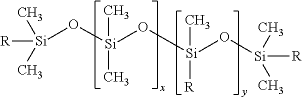

wherein each R independently represents —OH, —CH═CH₂, —CH₃, or another alkyl or aryl group, and the degree of polymerization (DP) is the sum of subscripts x and y. For high consistency silicone rubber elastomers, the DP is typically in the range of 5000 to 10,000. Thus, the molecular weight of the polymers, which are generally called gums, used in the manufacture of high consistency silicone elastomers ranges from 350,000 to 750,000 or greater.

In some embodiments, the silicone rubber is a liquid silicone rubber elastomer. In liquid silicone rubber elastomers, the DP of the polymers used typically ranges from 10 to 1000, resulting in molecular weights ranging from 750 to 75,000. The polymer systems used in the formulation of these elastomers can be either a single polymer species or a blend of polymers containing different functionalities or molecular weights. The polymers are selected to impart specific performance attributes to the resultant elastomer products. For more information, see the article entitled “Comparing Liquid and High Consistency Rubber Elastomers: Which Is Right For You?” available at www.mddionline.com/article/comparing-liquid-and-high-consistency-silicone-rubber-elastomers-which-right-you.

In certain embodiments, the silicone elastomer is a product of a platinum-catalyzed addition cured reaction. In certain embodiments, the silicone elastomer is a product of a platinum-catalyzed addition cure reaction of a reaction mixture comprising vinyl-functional polydimethylsiloxane and a methyl hydrogen polysiloxane.

In some other embodiments, the silicone elastomer can be made using a peroxide agent as a curative. In certain embodiments, the silicone elastomer is a non-reticulated (i.e., non-foamed), non-fiber reinforced backing layer.

In certain embodiments, the silicone elastomer further includes one or more fillers and/or other additive mixed therein. In certain embodiments, the silicone elastomer further includes a filler mixed therein. In certain embodiments, the silicone elastomer further includes an inorganic filler mixed therein. In certain embodiments, the inorganic filler includes silica, ceramic powder, metal particles, glass particles, metal oxides, or combinations thereof. In certain embodiments, the inorganic filler comprises silica.

In certain embodiments, the silicone elastomer further includes a pigment (e.g., carbon black), a heat stabilizer, a micropowder (e.g., PTFE) for abrasion resistance, or a combination thereof.

Suitable materials for the silicone backings or bondable substrates can be obtained commercially from, for example, Momentive (Waterford, N.Y.), Wacker Chemie (Munich, Germany), and Dow Corning (Midland, Mich.). In certain embodiments, the backing or bondable substrate is surface treated by a process that will enhance adhesion to an adhesive (thereby forming a treated surface). This is particularly desirable for backings or substrates that include silicone on the surface. Examples of surface treatments include, for example, plasma treatment, corona treatment, flame treatment, and chemical etching, among others (e.g., a primer coating for anchorage of silicone to a polyethylene terephthalate film is disclosed in U.S. Pat. No. 5,077,353 (Culbertson et al.)).

### Pressure Sensitive Adhesive

Pressure sensitive adhesives useful in the tapes of the present disclosure can be self tacky or require the addition of a tackifier. Such materials include, but are not limited to, tackified natural rubbers, tackified synthetic rubbers, tackified styrene block copolymers, self-tacky or tackified acrylate or methacrylate copolymers, self-tacky or tackified poly-alpha-olefins, and tackified silicones. Examples of suitable pressure sensitive adhesives are described in U.S. Pat. No. Re 24,906 (Ulrich), U.S. Pat. No. 4,833,179 (Young et al.), U.S. Pat. No. 5,209,971 (Babu et al.), U.S. Pat. No. 2,736,721 (Dexter), and U.S. Pat. No. 5,461,134 (Leir et al.), for example. Others are described in the Encyclopedia of Polymer Science and Engineering, vol. 13, Wiley-Interscience Publishers, New York, 1988, and the Encyclopedia of Polymer Science and Technology, vol. 1, Interscience Publishers, New York, 1964.

Useful natural-rubber pressure sensitive adhesives generally contain masticated natural rubber, one or more tackifying resins, and one or more antioxidants. Useful synthetic-rubber adhesives are generally rubbery elastomers, which are either inherently tacky or nontacky and require tackifiers. Inherently tacky (i.e., self-tacky) synthetic-rubber pressure sensitive adhesives include for example, butyl rubber, a copolymer of isobutylene with less than 3 percent isoprene, polyisobutylene, a homopolymer of isoprene, polybutadiene, or styrene/butadiene rubber.

Styrene block copolymer pressure sensitive adhesives generally comprise elastomers of the A-B or A-B-A type, wherein, in this context, A represents a thermoplastic polystyrene block and B represents a rubbery block of polyisoprene, polybutadiene, or poly(ethylene/butylene), and tackifying resins. Examples of the various block copolymers useful in block copolymer pressure sensitive adhesives include linear, radial, star, and tapered block copolymers. Specific examples include copolymers such as those available under the tradenames KRATON from Shell Chemical Co. (Houston, Tex.), and EUROPRENE SOL from EniChem Elastomers Americas, Inc. (Houston, Tex.). Examples of tackifying resins for use with such styrene block copolymers include aliphatic olefin-derived resins, rosin esters, hydrogenated hydrocarbons, polyterpenes, terpene phenolic resins derived from petroleum or terpentine sources, polyaromatics, coumarone-indene resins, and other resins derived from coal tar or petroleum and having softening points above about 85° C.

(Meth)acrylate (i.e., acrylate and methacrylate or “acrylic”) pressure sensitive adhesives generally have a glass transition temperature of about −20° C. or less and typically include an alkyl ester component such as, for example, isooctyl acrylate, 2-ethyl-hexyl acrylate, or n-butyl acrylate, and a polar component such as, for example, acrylic acid, methacrylic acid, ethylene vinyl acetate, or N-vinyl pyrrolidone. Preferably, acrylic pressure sensitive adhesives comprise about 80 wt-% to about 100 wt-% isooctyl acrylate and up to about 20 wt-% acrylic acid. The acrylic pressure sensitive adhesives may be inherently tacky or tackified using a tackifier such as a rosin ester, an aliphatic resin, or a terpene resin.

Poly-alpha-olefin pressure sensitive adhesives, also called poly(1-alkene) pressure sensitive adhesives, generally comprise either a substantially uncrosslinked polymer or an uncrosslinked polymer that may have radiation activatable functional groups grafted thereon as described in U.S. Pat. No. 5,209,971 (Babu et al.). Useful poly-a-olefin polymers include, for example, (C3-C8)poly(1-alkene) polymers. The poly-a-olefin polymer may be inherently tacky and/or include one or more tackifying materials such as resins derived by polymerization of (C5-C9)unsaturated hydrocarbon monomers, polyterpenes, synthetic polyterpenes, or the like.

Pressure sensitive silicone adhesives include two major components, a polymer or gum and a tackifying resin. The polymer is typically a high molecular weight polydimethylsiloxane or polydimethyldiphenylsiloxane, that contains residual silanol functionality (SiOH) on the ends of the polymer chain, or a block copolymer comprising polydiorganosiloxane soft segments and urea terminated hard segments. The tackifying resin is generally a three-dimensional silicate structure that is endcapped with trimethylsiloxy groups (OSiMe₃) and also contains some residual silanol functionality. Pressure sensitive silicone adhesives are described in U.S. Pat. No. 2,736,721 (Dexter). Silicone urea block copolymer pressure sensitive adhesive are described in U.S. Pat. No. 5,461,134 (Leir et al.), International Publication Nos. WO 96/034029 (Sherman et al.) and WO 96/035458 (Melancon et al.). Silicone polyoxamide pressure sensitive adhesive compositions are described in U.S. Pat. No. 7,371,464 (Sherman et al.).

### EXEMPLARY EMBODIMENTS

Embodiment 1 is a curable epoxy/thiol resin composition comprising: an epoxy resin component comprising an epoxy resin having at least two epoxide groups per molecule; a thiol component comprising a polythiol compound having at least two primary thiol groups; a silane-functionalized adhesion promoter; and a nitrogen-containing catalyst for curing the epoxy resin. In certain embodiments, the silane-functionalized adhesion promoter has the following general Formula (II): (X)ₘ—Y—(Si(R²)₃)ₙ, wherein: X is an epoxy or thiol group, Y is an aliphatic group, m and n are independently 1-3, and each R² is independently an alkoxy group. In certain embodiments, the epoxy resin component and/or the thiol component are selected to provide a cured polymeric material that does not crack according to the Cylindrical Mandrel Bend Test and/or has a tensile elongation of at least 100% according to the Tensile Modulus and Elongation Test.

Embodiment 2 is the curable epoxy/thiol resin composition of embodiment 1 which is a one-part composition.

Embodiment 3 is the curable epoxy/thiol resin composition of embodiment 1 or 2 further comprising a cure inhibitor.

Embodiment 4 is the curable epoxy/thiol resin composition of embodiment 3 wherein the cure inhibitor comprises a Lewis acid.

Embodiment 5 is the curable epoxy/thiol resin composition of embodiment 4 wherein the Lewis acid cure inhibitor is selected from a borate ester, CaNO₃, MnNO₃, and a combination thereof.

Embodiment 6 is the curable epoxy/thiol resin composition of any of embodiments 3 to 5 wherein the cure inhibitor comprises a weak Bronsted acid.

Embodiment 7 is the curable epoxy/thiol resin composition of embodiment 6 wherein the weak Bronsted acid cure inhibitor is selected from a barbituric acid derivative, 1,3-cyclohexanedione, 2,2-dimethyl-1,3-dioxane-4,6-dione, and a combination thereof.

Embodiment 8 is the curable epoxy/thiol resin composition of embodiment 7 wherein the barbituric acid derivative is a barbituric acid compound substituted at one or more of the 1, 3, and/or 5 N positions with an aliphatic, cycloaliphatic, or aromatic group.

Embodiment 9 is the curable epoxy/thiol resin composition of embodiment 8 wherein the

barbituric acid derivative is of Formula (IV):

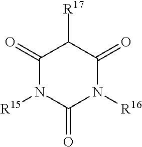

wherein one or more of the R¹⁵, R¹⁶, and R¹⁷ groups are represented by hydrogen, an aliphatic group, a cycloaliphatic group, or an aromatic group (e.g., phenyl), optionally further substituted in any position with one or more of (C1-C4)alkyl, —OH, halide (F, Br, Cl, I), phenyl, (C1-C4)alkylphenyl, (C1-C4)alkenylphenyl, nitro, or —OR¹⁸ where R¹⁸ is phenyl, a carboxylic group, a carbonyl group, or an aromatic group and R¹⁸ is optionally substituted with (C1-C4)alkyl, —OH, or halide; and further wherein at least one of the R¹⁵, R¹⁶, and R¹⁷ groups is not hydrogen. In certain embodiments, at least two of the R¹⁵, R¹⁶, and R¹⁷ groups are not hydrogen.

Embodiment 10 is the curable epoxy/thiol resin composition of embodiment 9 wherein the barbituric acid derivative is selected from 1-benzyl-5-phenylbarbituric acid, 1-cycloheyl-5-ethylbarbituric acid, 1,3-dimethylbarbituric acid, and a combination thereof.

Embodiment 11 is the curable epoxy/thiol resin composition of any of embodiments 3 to 10 wherein the cure inhibitor is present in the curable epoxy/thiol resin composition in an amount of at least 0.01 wt-%, based on the total weight of the epoxy/thiol resin composition.

Embodiment 12 is the curable epoxy/thiol resin composition of any of embodiments 7 to 11 wherein the barbituric acid derivative is present in the curable epoxy/thiol resin compositions in an amount of up to 1 wt-%, based on the total weight of the epoxy/thiol resin composition.

Embodiment 13 is the curable epoxy/thiol resin composition of any of embodiments 2 to 12 which is curable at a temperature of at least 50° C.

Embodiment 14 is the curable epoxy/thiol resin composition of embodiment 13 which is curable at a temperature of at least 60° C.

Embodiment 15 is the curable epoxy/thiol resin composition of any of embodiments 2 to 14 which is curable at a temperature of up to 80° C.

Embodiment 16 is the curable epoxy/thiol resin composition of embodiment 1 which is a two-part composition comprising a base and an accelerator, wherein the base comprises the epoxy resin component and the silane-functionalized adhesion promoter, and the accelerator comprises the thiol component and the nitrogen-containing catalyst.

Embodiment 17 is the curable epoxy/thiol resin composition of embodiment 16 which is curable at room temperature.

Embodiment 18 is the curable epoxy/thiol resin composition of any of the preceding embodiments wherein the epoxy resin comprises a polyglycidyl ether of a polyhydric phenol, a reaction product of a polyhydric alcohol with epichlorohydrin, an epoxidised (poly)olefinic resin, an epoxidised phenolic novolac resin, an epoxidised cresol novolac resin, a cycloaliphatic epoxy resin, a glycidyl ether ester, a polyglycidyl ester, a urethane modified epoxy resin, or a combination thereof.

Embodiment 19 is the curable epoxy/thiol resin composition of any of the preceding embodiments wherein the epoxy resin component is flexible.

Embodiment 20 is the curable epoxy/thiol resin composition of embodiment 19 wherein the flexible epoxy resin component comprises an epoxy compound having a linear or cyclic aliphatic structure; a diglycidyl ether of a polyether; a cashew nut oil or other natural oil; an alkyl-functionalized diglycidyl ether of Bisphenol A; an ethoxylated or propoxylated bisphenol A diglycidyl epoxy derivative; or a combination thereof.

Embodiment 21 is the curable epoxy/thiol resin composition of any of the preceding embodiments wherein the epoxy resin component further comprises a reactive diluent.

Embodiment 22 is the curable epoxy/thiol resin composition of embodiment 21 wherein the reactive diluent has a viscosity of less than 250 mPa·s.

Embodiment 23 is the curable epoxy/thiol resin composition of embodiment 21 or 22 wherein the reactive diluent comprises a reactive monofunctional epoxy resin.

Embodiment 24 is the curable epoxy/thiol resin composition of embodiment 23 wherein the monofunctional epoxy resin comprises a (C6-C28)alkyl group.

Embodiment 25 is the curable epoxy/thiol resin composition of embodiment 24 wherein the monofunctional epoxy resin comprises (C6-C28)alkyl glycidyl ethers, (C6-C28)fatty acid glycidyl esters, (C6-C28)alkylphenol glycidyl ethers, or combinations thereof.

Embodiment 26 is the curable epoxy/thiol resin composition of any of the preceding embodiments wherein the epoxy resin component is present in an amount of at least 20 wt-%, at least 25 wt-%, at least 30 wt-%, at least 35 wt-%, at least 40 wt-%, or at least 45 wt-%, based on the total weight of the curable epoxy/thiol resin composition.

Embodiment 27 is the curable epoxy/thiol resin composition of any of the preceding embodiments wherein the epoxy resin component is present in an amount of up to 80 w-%, up to 75 wt-%, or up to 70 wt-%, based on the total weight of the curable epoxy/thiol resin composition.

Embodiment 28 is the curable epoxy/thiol resin composition of any of the preceding embodiments wherein the polythiol compound comprises trimethylolpropane tris(beta-mercaptopropionate), trimethylolpropane tris(thioglycolate), pentaerythritol tetrakis(thioglycolate), pentaerythritol tetrakis(beta-mercaptopropionate), dipentaerythritol poly(beta-mercaptopropionate), ethylene glycol bis(beta-mercaptopropionate), a (C1-C12)alkyl polythiol, a (C6-C12)aromatic polythiol, or a combination thereof.

Embodiment 29 is the curable epoxy/thiol resin composition of any of the preceding embodiments wherein the thiol component is flexible.

Embodiment 30 is the curable epoxy/thiol resin composition of embodiment 29 wherein the flexible thiol component comprises a compound having a linear aliphatic structure, a cyclic aliphatic structure, or a combination thereof.

Embodiment 31 is the curable epoxy/thiol resin composition of any of the preceding embodiments wherein the thiol component is present in an amount of at least 25 wt-%, at least 30 wt-%, or at least 35 wt-%, based on a total weight of the curable epoxy/thiol resin composition.

Embodiment 32 is the curable epoxy/thiol resin composition of any of the preceding embodiments wherein the thiol component is present in an amount of up to 70 wt-%, up to 65 wt-%, up to 60 wt-%, up to 55 wt-%, up to 50 wt-%, up to 45 wt-%, or up to 40 wt-%, based on a total weight of the curable epoxy/thiol resin composition.

Embodiment 33 is the curable epoxy/thiol resin composition of any of the preceding embodiments wherein the epoxy resin component and the thiol component are present in a ratio of from 0.5:1 to 1.5:1, or from 0.75:1 to 1.3:1 (epoxy:thiol equivalents).

Embodiment 34 is the curable epoxy/thiol resin composition of any of the preceding embodiments wherein the silane-functionalized adhesion promoter has the following general Formula (II):

(X)ₘ—Y—(Si(R²)₃)ₙ

wherein: X is an epoxy or thiol group, Y is a (C2-C6)aliphatic group, m and n are each 1, and each R² is independently a methoxy or ethoxy group; and

Embodiment 35 is the curable epoxy/thiol resin composition of embodiment 34 wherein the compound of Formula (II) is selected from 3-glycidoxypropyltriethoxysilane 5,6-epoxyhexyltriethoxysilane, 2-(3,4-epoxycyclohexyl)ethyltriethoxysilane, mercaptopropyltriethoxysilane, s-(octanoyl)mercaptopropyltriethoxysilane, hydroxy(polyethyleneoxy)propyltriethoxysilane, and a combination thereof.

Embodiment 36 is the curable epoxy/thiol resin composition of any of the preceding embodiments wherein the silane-functionalized adhesion promoter is present in an amount of at least 0.1 part, or at least 0.5 part, per 100 parts of the combined weights of the epoxy resin and thiol components.

Embodiment 37 is the curable epoxy/thiol resin composition of any of the preceding embodiments wherein the silane-functionalized adhesion promoter is present in an amount of up to 5 parts, or up to 2 parts, per 100 parts of the combined weights of the epoxy resin and thiol components.

Embodiment 38 is the curable epoxy/thiol resin composition of any of the preceding embodiments wherein the nitrogen-containing catalyst is solid at room temperature.

Embodiment 39 is the curable epoxy/thiol resin composition of any of the preceding embodiments wherein the nitrogen-containing catalyst is capable of activation at temperatures at 50° C. or greater to effect the thermal curing of the epoxy resin.

Embodiment 40 is the curable epoxy/thiol resin composition of any of the preceding embodiments wherein the nitrogen-containing catalyst is an amine-containing catalyst.

Embodiment 41 is the curable epoxy/thiol resin composition of embodiment 40 wherein the amine-containing catalyst has at least two groups of formula —NR³H, wherein R³ is selected from hydrogen, alkyl, aryl, alkaryl, or aralkyl.

Embodiment 42 is the curable epoxy/thiol resin composition of embodiment 40 wherein the amine-containing catalyst comprises a reaction product of phthalic anhydride and an aliphatic polyamine.

Embodiment 43 is the curable epoxy/thiol resin composition of embodiment 40 wherein the amine-containing catalyst comprises a reaction product of: (i) a polyfunctional epoxy compound; (ii) an imidazole compound, such as 2-ethyl-4-methylimidazole; and (iii) phthalic anhydride.

Embodiment 44 is the curable epoxy/thiol resin composition of embodiment 40 wherein the amine-containing catalyst comprises a reaction product of a compound having one or more isocyanate groups in its molecule with a compound having at least one primary or secondary amino group in its molecule.

Embodiment 45 is the curable epoxy/thiol resin composition of embodiment 40 wherein the amine-containing catalyst comprises 2-heptadeoylimidazole, 2-phenyl-4,5-dihydroxymethylimidazole, 2-phenyl-4-methyl-5-hydroxymethylimidazole, 2-phenyl-4-benzyl-5-hydroxymethylimidazole, 2,4-diamino-8-2-methylimidazolyl-(1)-ethyl-5-triazine, or a combination thereof.

Embodiment 46 is the curable epoxy/thiol resin composition of embodiment 40 wherein the amine-containing catalyst comprises products of triazine with isocyanuric acid, succinohydrazide, adipohydrazide, isophtholohydrazide, o-oxybenzohydrazide, salicylohydrazide, or a combination thereof.

Embodiment 47 is the curable epoxy/thiol resin composition of embodiment 40 wherein the amine-containing catalyst comprises an imidazole, an imidazole-salt, an imidazoline, or a combination thereof.

Embodiment 48 is the curable epoxy/thiol resin composition of embodiment 40 wherein the amine-containing catalyst comprises an aromatic tertiary amine having the structure of

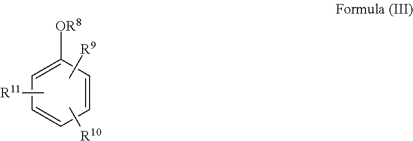

wherein: R⁸ is hydrogen or an alkyl group; R⁹, R¹⁰, and R¹¹ are, independently, hydrogen or CHNR¹²R¹³, wherein at least one of R⁹, R¹⁰, and R¹¹ is CHNR¹²R¹³; and R¹² and R¹³ are, independently, alkyl groups.

Embodiment 49 is the curable epoxy/thiol resin composition of any of the preceding embodiments wherein the nitrogen-containing catalyst is present in the curable epoxy/thiol resin composition in an amount of at least 1 part, at least 2 parts, at least 3 parts, at least 4 parts, or at least 5 parts, per 100 parts of the epoxy resin component.

Embodiment 50 is the curable epoxy/thiol resin composition of any of the preceding embodiments wherein the nitrogen-containing catalyst is present in the curable epoxy/thiol resin composition in an amount of up to 45 parts, up to 40 parts, up to 35 parts, up to 30 parts, up to 25 parts, or up to 20 parts, per 100 parts of the epoxy resin component.

Embodiment 51 is the curable epoxy/thiol resin composition of any of the preceding embodiments which is stable at room temperature for a period of at least 2 weeks, at least 4 weeks, or at least 2 months.

Embodiment 52 is a method of curing a curable, one-part epoxy/thiol resin composition, the method comprising: providing a one-part curable epoxy/thiol resin composition of any of embodiments 2 to 15 and 17 to 51 as dependent on embodiment 2; and heating the curable, one-part epoxy/thiol resin composition to a temperature of at least 50° C.

Embodiment 53 is the method of embodiment 52 comprising heating the curable, one-part epoxy/thiol resin composition to a temperature of up to 80° C.

Embodiment 54 is the method of embodiment 53 comprising heating the curable, one-part epoxy/thiol resin composition to a temperature of 60-65° C.

Embodiment 55 is a method of curing a curable, one-part epoxy/thiol resin composition, the method comprising: providing a curable epoxy/thiol resin composition in two parts of any of embodiments 16 to 51 as dependent on embodiment 16; combining the base and the accelerator to form a base/accelerator mixture; and providing conditions sufficient to cure the base/accelerator mixture (e.g., allowing the base and accelerator mixture to react at a temperature of at least room temperature).

Embodiment 56 is an article comprising: a film comprising a cured polymeric material formed from the curable epoxy/thiol resin composition of any of embodiments 1 to 51.

Embodiment 57 is the article of embodiment 56 further comprising a pressure sensitive adhesive layer disposed on at least one major surface of the film.

Embodiment 58 is the article of embodiment 57 wherein the film is disposed on a backing and forms a tie layer between the backing and the pressure sensitive adhesive layer, thereby forming a tape.

Embodiment 59 is the article of embodiment 57 or 58 wherein the pressure sensitive adhesive layer comprises a pressure sensitive silicone adhesive.

Embodiment 60 is the article of embodiment 56 wherein the film is disposed on a first major surface of a substrate.

Embodiment 61 is the article of embodiment 60 further comprising a pressure sensitive adhesive disposed on a second major surface of the substrate opposite the first major surface.

Embodiment 62 is a silicone tape comprising: a silicone backing having a major surface that is surface treated; and a tie layer disposed on the treated major surface of the silicone backing, wherein the tie layer comprises a cured polymeric material formed from a curable epoxy/thiol resin composition of any of embodiments 1 to 51; and a pressure sensitive silicone adhesive disposed on the tie layer.

Embodiment 63 is a method of bonding two substrates, wherein the method includes: providing two substrates, at least one of which is a surface-treated silicone substrate (which may be a major surface or an edge surface of a substrate); providing a curable epoxy/thiol resin composition of any of embodiments 1 to 51; applying the curable epoxy/thiol resin composition to at least one surface of at least one of the substrates; contacting a surface of each of the two substrates (thereby forming contacting surfaces) such that the curable epoxy/thiol resin composition is disposed between the contacting surfaces and is in contact with the treated surface of the silicone substrate; and providing conditions effective to cure the curable epoxy/thiol resin composition.

Embodiment 64 is the method of embodiment 63 wherein the curable epoxy/thiol resin composition is a curable one-part epoxy/thiol resin composition according to any of embodiments 2 to 15 and 17 to 51 as dependent on embodiment 2; and wherein curing comprises heating the curable, one-part epoxy/thiol resin composition to a temperature of at least 50° C.

Embodiment 65 is the method of embodiment 64 wherein curing comprises heating the curable, one-part epoxy/thiol resin composition to a temperature of up to 80° C.

Embodiment 66 is the method of embodiment 65 wherein curing comprises heating the curable, one-part epoxy/thiol resin composition to a temperature of 60-65° C.

Embodiment 67 is the method of embodiment 63 wherein the curable epoxy/thiol resin composition is a curable epoxy/thiol resin composition in two parts according to any of embodiments 16 to 51 as dependent on embodiment 16; wherein applying the curable epoxy/thiol resin composition to at least one surface of at least one of the substrates comprises combining the base and the accelerator to form a mixture and applying the mixture to at least one surface of at least one of the substrates; and curing comprises allowing the base and accelerator mixture to react (e.g., at room temperature).

### EXAMPLES

Objects and advantages of various embodiments of this invention are further illustrated by the following examples, but the particular materials and amounts thereof recited in these examples, as well as other conditions and details, should not be construed to unduly limit this invention. These examples are merely for illustrative purposes only and are not meant to be limiting on the scope of the appended claims.

### Materials

| Designation | Description |
|---|---|
| PY4122 | A flexible, difunctional bis-phenol A based epoxy resin having an epoxy |
| | equivalent weight of 313 to 390 grams/equivalent and the majority (at |
| | least 60 wt-%) which is 2,2′-[(1-methylethylidene)bis[4,1- |
| | phenyleneoxy[1-(butoxymethyl)ethylene]oxymethylene]]bisoxirane, |
| | available under the tradename ARALDITE PY 4122 Resin from |
| | Huntsman Corporation, The Woodlands, TX. |
| | 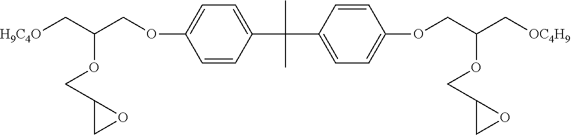 |
| MX150 | A general purpose Bisphenol A epoxy resin containing 40 wt-% of |
| | polybutadiene (PBd) core-shell rubber (CSR) particles, available under |
| | the tradename KANE ACE MX-150 from Kaneka Corporation, Tokyo, |
| | Japan. |
| Z6040 | Glycidylpropyl trimethoxysilane, an adhesion promoter available under |
| | the tradename DOW CORNING Z-6040 SILANE from Dow Corning |
| | Corporation, Midland, MI. |
| L07N | An Epoxy-Phenol-Borate compound, a viscous liquid which is described |
| | as an Adduct Stabilizer used to provide improved storage stability to |
| | epoxy resins containing adducted imidazole and amine curing agents, |
| | available under the tradename SHIKOKU L-07N from Shikoku |
| | Chemicals Corporation, Marugame, Kagawa Prefecture, Japan. |
| EPON 828 | A difunctional bis-phenol A/epichlorohydrin derived liquid epoxy resin |
| | having an epoxide equivalent weight of 185 to 192 grams/equivalent, |
| | available under the tradename EPON 828 from Hexion Incorporated, |
| | Columbus, OH. |
| BPBA | 1-Benzyl-5-phenyl barbituric acid, a substituted barbituric acid derivative |
| | having a molecular weight of 294.3 grams/mole, available from |
| | Chemische Fabrik Berg GmbH, Bitterfeld-Wolfen, Germany. This was |
| | employed as a 5 wt-% solution in EPON 828. |
| CE10P | The glycidyl ester of versatic acid 10, a synthetic saturated |
| | monocarboxylic acid of highly branched C10 isomers available under the |
| | tradename CARDURA E10P GLYCIDYL ESTER from Hexion |
| | Incorporated, Columbus, OH. |
| FXR 1081 | A latent epoxy curing agent and curing accelerator, available under the |
| | tradename FUJICURE FXR-1081 from T&K Toka Corporation, Iruma- |
| | Gun, Saitama, Japan. |
| TMPMP | Trimethylolpropane tris(3-mercaptopropionate), a trifunctional polythiol, |
| | curing agent having a molecular weight of 399 grams/mole, available |
| | under the tradename THIOCURE TMPMP from Evans Chematics, |
| | Teaneck, NJ. |
| ETTMP | Ethoxylated-Trimethylolpropane tris (3-Mercaptopropionate), a |
| | trifunctional polythiol curing agent having a molecular weight of |
| | approximatly 700 grams/mole, available under the tradename |
| | THIOCURE ETTMP700 from Evans Chematics, Teaneck, NJ. |
| PEMP | Pentaerythitol tetra(3-mercaptopropionate), a tetrafunctional polythiol |
| | curing agent having a molecular weight of 489 grams/mole, available |
| | under the tradename THIOCURE PETMP from Evans Chematics, |
| | Teaneck, NJ. |
| K54 | 2,4,6-Tri(dimethylaminomethyl)phenol, a curing catalyst, available |
| | under the tradename ANCAMINE K-54 from Evonik Industries, Essen, |
| | Germany. |
| DBU | 1,8-Diazabicyclo(5.4.0)unde-7-ene, a curing catalyst, available from |
| | Millipore Sigma, St. Louis, MO. |
| Silicone Rubber 1 | A high consistency silicone-rubber based polymer that is the product of a |
| | platinum catalyzed addition cure of vinyl-functional |
| | polydimethylsiloxane and methyl hydrogen polysiloxane, formulated |
| | with silica filler, black pigment, polytetrafluoroethylene micropowder, |
| | and heat stabilizers, and having a Shore D hardness of 35 and a thickness |
| | of 0.043 inch (1.1 millimeters). The silicone rubber substrate was corona |
| | treated no more than two weeks before use. |
| Silicone Rubber 2 | A peroxide-cured high consistency rubber silicone-based polymer that is |
| | the reaction of vinyl-functional polydimethylsiloxane and methyl |
| | hydrogen polysiloxane, with the decomposition products of dicumyl |
| | peroxide (acetophenone and phenyl-2-propanol), formulated with a silica |
| | filler to have a Shore D hardness of about 35 (or a Shore A hardness of |
| | 72) after curing, and further formulated with black pigment, heat |
| | stabilizers, and PTFE micropowder. This material is available under the |
| | product designation SLM15029 from Wacker Chemie, Munich, |
| | Germany. The silicone rubber substrate was corona treated no more than |
| | two weeks before use. |
| Silicone Rubber 3 | A peroxide cured, silicone rubber sheet containing red pigment, having a |
| | Shore D hardness of 25, and a thickness of approximately 0.062 inch |
| | (1.59 millimeters), obtained as 60 DURO RED SPEC GRADE |
| | SILICONE, Part Number DSP6038GP-062 from Diversified Silicone |
| | Products, Santa Fe Springs, CA. The silicone rubber substrate was wiped |
| | clean with toluene then corona treated no more than two weeks before |
| | use. |
| 91022 | A silicone adhesive transfer tape having 3M SILICONE ADHESIVE |
| | with an adhesive thickness of 0.002 inch (0.05 millimeters) on a |
| | polyester film release liner, available under the tradename 3M |
| | ADHESIVE TRANSFER TAPE 91022 from 3M Company, St. Paul, |
| | MN. |
| 9472 | An acrylic adhesive transfer tape having 3M ADHESIVE 300 with an |
| | adhesive thickness of 0.005 inch (0.13 millimeters) on a densified Kraft |
| | paper release liner, available under the tradename 3M ADHESIVE |
| | TRANSFER TAPE 9472 from 3M Company, St. Paul, MN. |

### Test Methods

### T-Peel Adhesion Strength

An uncured epoxy resin composition was applied onto the corona-treated surface of a silicone sheet measuring 6 inches wide by 8 inches long (15.2 centimeters by 20.3 centimeters) and having a thickness ranging from 0.043 to 0.059 inch (1.1 to 1.5 millimeters) using a knife coating apparatus to provide a coated thickness of 0.003 inch (76 micrometers). Prior to application, a one inch (2.5 centimeters) area along the width at one end of the sheet was taped off to prevent this area from being coated with composition. After application, the corona-treated surface of a second sample of the same silicone sheet was pressed against the uncured epoxy resin composition. This assembly was then cured using one of the following protocols: 1) for one hour at 100° C. in an oven (for the one-part compositions); 2) 24 hours at room temperature followed by 30 minutes at 80° C. (Example 8); or 3) for 24 hours at room temperature (Example 9). After curing, 0.5 inch (12.5 millimeters) was trimmed off both of the lengthwise edges of the resulting laminate structure. Next, five samples measuring 1 inch by 8 inches (2.54 centimeters by 20.3 centimeters) were cut and evaluated for peel adhesion (bond) strength at room temperature in a T-peel mode (180 degree angle of peel) using a tensile testing machine with a 200 pound-force load cell. The crosshead speed was 12 inches/minute (30.5 centimeters/minute). One free end (resulting from the taped off section) of the sample was clamped in the upper jaw of the tensile testing machine and the remaining free end was clamped in the lower jaw. Data obtained from the first inch of peel length was ignored and the data from the next four inches was recorded. The average of three to five samples was reported in ounces/inch (Newtons/decimeter). The failure mode(s) was also recorded: cohesive (the failure occurred within the epoxy resin composition) or substrate (the silicone rubber tore).

### Tensile Modulus and Elongation

Tensile tests were conducted according to the test method ASTM 638-08: “Standard Test Method for Tensile Properties of Plastics.” Tensile test specimens were prepared by knife coating uncured epoxy resin compositions between two release liners to provide a nominal thickness of 0.012 inch (0.30 millimeters), and then curing them in an oven at 100° C. for one hour. The two release liners were removed to provide a cured film of epoxy resin. Tensile elongation samples were then punched out of the film using an ASTM 638-08 Type V die. The specimens were tested at a strain rate of 5 centimeters/minute using an INSTRON Model 1122 Tensile Tester (from Instron, Norwood, Mass.). The modulus was reported in pounds per square inch (psi) and Megapascals (MPa), and ultimate (at break) elongation was reported in percentage. The crosshead movement was used as a measure of elongation.

### Cylindrical Mandrel Bend

An uncured epoxy resin composition was applied onto the corona-treated surface of a silicone sheet (Silicone Rubber 1) measuring 2.5 inches wide by 6 inches long (6.4 centimeters by 15.2 centimeters) using a knife coating apparatus to provide a coated thickness of 0.012 inch (0.3 millimeters), and then cured in an oven at 100° C. for one hour. After curing, the sample was evaluated for crack formation upon sample bending using an ELCOMETER 1506 cylindrical mandrel bend tester equipped with a 4 millimeter diameter Mandrel. To test the material, the 2.5 inch (6.4 centimeter) wide end of the sample was clamped into the lower jaw of the Mandrel testing apparatus. The testing apparatus was then assembled in such a way that the coated sample was pinched between the roller and the Mandrel bar; followed by rotating the rollers over the mandrel bar such that the coated sample was bent into an inverted “U” shape around the Mandrel. The sample was then released from the apparatus and inspected for crack formulation or delamination along the portion of the material that had been bent. If any cracks were present or there was observed delamination between the silicone sheet and cured epoxy resin composition the result was recorded as “Fail”; if no cracks were present anywhere on the bent surface and no delamination was observed the result was recorded as “Pass.”

### Cure Inhibitor Solubility

Cure inhibitor solubility was evaluated by means of optical transmission and clarity using a BYK GARDNER HAZE-GARD PLUS from BYK Gardner (Silver Spring, Md.). The instrument was referenced against air during the measurements. For transmission and clarity measurements of the uncured resin, a TEFLON spacer was mounted between two clean glass microscope slides, having an average thickness of 0.039 inch (0.99 mm), such that the spacer was outside the optical measurement area and created a gap of approximately 0.072 inch (1.83 mm) into which cure-inhibitor-containing resin was placed. Clamps, also mounted outside the measurement area, were used to hold the glass pieces tightly to the spacer and ensure that the gap spacing was restricted to the thickness of the spacer. Five individual measurements of the transmission, haze, and clarity were made on the sample. The average percent transmission and clarity were reported. For clarity it is desirable to have values of 80%, 85%, 90% or even 95% or higher. For transmission it is desirable to have values of 80%, 85%, or even 90% or higher.

### Corona Treatment of Silicone Substrates

Silicone rubber substrates were corona treated under an ambient air atmosphere at a power level of 0.2 kilowatt and a feed rate of 30 feet/minute (9.1 meters/minute) to provide a total dosage of 0.32 Joule/square centimeter using a Model SS1908 Corona Treater from Enercon Industries Corporation (Menomonee Falls, Wis.). The silicone rubber substrates were corona treated no more than two weeks before use.

### EXAMPLES

### Cure Inhibitor Solubility Evaluation

1-Benzyl-5-phenyl-barbituric acid (BPBA), a cure inhibitor, was evaluated for its' solubility characteristics as follows. A mixture was prepared using the materials and amounts (in parts by weight) shown in Table A and the following procedure. The materials were added to a MAX 60 SPEEDMIXER cup from Flacktek Inc. (Landrum, S.C.) and mixed at 2,250 revolutions per minute (rpm) for 30 seconds using a DAC 600 FVZ SPEEDMIXER from FlackTek Inc. (Landrum, S.C.), followed by heating for 20 seconds in a 1,000 Watt commercial microwave oven. Next, the sample was remixed in the DAC 600 FVZ SPEEDMIXER for two minutes at 2,250 rpm, and degassed using a DAC 600.2 VAC-P SPEEDMIXER from FlackTek Inc. (Landrum, S.C.). The degassing cycle was as follows: 1) mix sample for 20 seconds at 1,000 rpm at atmospheric pressure; 2) mix sample for two minutes at 1,500 rpm while drawing a vacuum down to a final pressure of 30 Torr (4 KiloPascals); and 3) mix sample for 20 seconds at 1,000 rpm while venting to atmospheric pressure. The resulting sample was evaluated for transmittance and clarity as described in the “Cure Inhibitor Solubility” test method above. The results are shown in Table A below. In addition the sample was evaluated by unaided eye for the presence of insoluble material.

TABLE A
Resin Compositions and Stabilizer Stability

| Material | BPBA | Control* |
|---|---|---|
| EPON 828 (parts by weight) | 47.5 | none |
| TMPMP (parts by weight) | 47.5 | none |
| l-Benzyl-5-phenyl-barbituric acid (parts by weight) | 5 | none |
| Transmission (%) | 92.3 | 86.0 |
| Clarity (%) | 99.6 | 99.7 |
| Visible Insoluble Material | No | NA |

*Control was a measurement of the two glass plates with TEFLON spacer between them.
NA: Not applicable.

High transmission and clarity values are indicative of a homogeneous solution with no insoluble components. The results in Table A, above, indicate the substituted barbituric acid derivatives were soluble in the resin compositions shown at levels as high as 5 wt-%. In comparison, the unsubstituted barbituric acid sample exhibited significantly lower transmission and clarity, in addition to containing visibly insoluble material.

### Epoxy Resin Compositions A and B, and Comparative Epoxy Resin Composition A (CR-A)

One-part epoxy resin bonding compositions were prepared using the materials and amounts shown in Table 1 as follows. The materials, except for FXR 1081, were added to a MAX 60 SPEEDMIXER cup from FlackTek, Inc. (Landrum, S.C.) and mixed at 1,500 rpm for one minute using a DAC 600 FVZ SPEEDMIXER from FlackTek, Inc. (Landrum, S.C.). To each mixture was then added FXR 1081 followed by further mixing at 1,500 rpm for one minute to obtain uncured epoxy resin bonding compositions.

TABLE 1
Uncured Epoxy Resin Bonding Compositions

| Epoxy | Material (wt-%) | | | | | | | |
|---|---|---|---|---|---|---|---|---|
| Resin | | | | | BPBA | | | |
| Composition | PY4122 | MX150 | Z6040 | L07N | Solution | CE10P | FXR1081 | TMPMP |
| A | 53.00 | 0.00 | 2.00 | 0.00 | 3.00 | 8.00 | 7.00 | 27.00 |
| B | 38.11 | 11.83 | 1.77 | 3.54 | 0.00 | 8.81 | 8.88 | 27.06 |
| CR-A | 54.08 | 0.00 | 0.00 | 0.00 | 3.06 | 8.16 | 7.14 | 27.55 |

### Examples 1-4 and Comparative Example 1 (CE-1)

The peel adhesion strengths between various silicone rubbers and cured Epoxy Resin Compositions A and B, and cured Comparative Epoxy Resin Composition A were evaluated according to the test method “T-Peel Adhesion Strength” described above. The results are shown in Table 2 below.

TABLE 2
Peel Adhesion Strengths

| | Epoxy Resin | | Toughening | Silicone | Silicone | Surface | Peel | | Failure |
|---|---|---|---|---|---|---|---|---|---|
| Ex. | Composition | Silane | Agent | Rubber | Cure Type | Treatment | oz/in. (N/dm) | | Mode |
| 1 | A | yes | no | 1 | Platinum | Corona | 76.5 | (83.7) | Cohesive |
| CE-1 | CR-A | no | no | 1 | Platinum | Corona | 24.2 | (26.5) | Cohesive |
| 2 | B | yes | yes | 1 | Platinum | Corona | 114.3 | (125.1) | Cohesive |
| 3 | B | yes | yes | 2 | Peroxide | Corona | 220.5 | (241.3) | Substrate |
| 4 | B | yes | yes | 3 | Peroxide | Toluene | 103.9 | (113.7) | Cohesive/ |
| | | | | | | wipe then | | | Substrate |
| | | | | | | Corona | | | |

Examples 2-4, which contained toughening agent, silane-functionalized adhesion promoter, and a flexible epoxy component exhibited the highest peel adhesion strengths. These results were observed over a variety of silicone rubber substrates. Example 1, which contained silane-functionalized adhesion promoter but not toughening agent, exhibited significantly higher peel adhesion strength relative to Comparative Example 1 which did not contain toughening agent or silane-functionalized adhesion promoter.

Examples 1, 2, and Comparative Example 1 were also evaluated for their tensile and crack resistance properties according to the “Tensile Modulus and Elongation” and “Cylindrical Mandrel Bend” test methods described above. The results are shown in Table 3 below. Comparative Example 1 failed the Mandrel Test due to delamination of the film from the silicone surface.

TABLE 3
Tensile and Mandrel Bend Properties

| | Epoxy Resin | Tensile Modulus | Tensile | Mandrel |
|---|---|---|---|---|
| Example | Composition | psi (MPa) | Elongation (%) | Test |
| 1 | A | 155 (1.1) | 252 | Pass |
| CE-1 | CR-A | 467 (3.2) | 246 | Fail |
| 2 | B | 133 (0.9) | 295 | Pass |

### Epoxy Resin Compositions C, D, and E, and Comparative Epoxy Resin Compositions B and C (CR-B and CR-C)

One-part epoxy resin bonding compositions were prepared using the materials and amounts shown in Table 4 as follows. The materials, except for FXR 1081, were added to a MAX 60 SPEEDMIXER cup from FlackTek, Inc. (Landrum, S.C.) and mixed at 1,500 rpm for one minute using a DAC 600 FVZ SPEEDMIXER from FlackTek, Inc. (Landrum, S.C.). To each mixture was then added FXR 1081 followed by further mixing at 1,500 rpm for one minute to obtain uncured epoxy resin bonding compositions.

TABLE 4
Uncured Epoxy Resin Bonding Compositions

| Epoxy | Material (wt-%) | | | | | | | | |
|---|---|---|---|---|---|---|---|---|---|
| Resin | | EPON | | BPBA | | | | ETTMP | |
| Composition | PY4122 | 828 | Z6040 | Solution | CE10P | FXR1081 | TMPMP | 700 | PEMP |
| C | 0.00 | 43.25 | 2.00 | 3.00 | 8.00 | 7.00 | 36.75 | 0.00 | 0.00 |
| D | 61.90 | 0.00 | 2.00 | 3.00 | 0.00 | 7.00 | 26.10 | 0.00 | 0.00 |
| E | 0.00 | 36.80 | 2.00 | 3.00 | 0.00 | 7.00 | 0.00 | 51.20 | 0.00 |
| CR-B | 0.00 | 50.50 | 2.00 | 3.00 | 0.00 | 7.00 | 37.50 | 0.00 | 0.00 |
| CR-C | 0.00 | 52.30 | 2.00 | 3.00 | 0.00 | 7.00 | 0.00 | 0.00 | 35.70 |

### Examples 5-7 and Comparative Examples 2 and 3 (CE-2 and CE-3)

The tensile properties of cured Epoxy Resin Compositions C, D, and E, and cured Comparative Epoxy Resin Compositions B and C (CR-B and CR-C) were evaluated for their tensile and crack resistance properties according to the “Tensile Modulus and Elongation” and “Cylindrical Mandrel Bend” test methods described above. The results are shown in Table 5 below.

TABLE 5
Tensile and Mandrel Bend Properties

| | Epoxy Resin | Tensile Modulus | | Tensile | Mandrel |
|---|---|---|---|---|---|
| Example | Composition | psi (MPa) | | Elongation (%) | Test |
| 5 | C | 9838 | (67.8) | 214 | Pass |
| 6 | D | 148 | (1.0) | 203 | Pass |
| 7 | E | 477 | (3.3) | 135 | Pass |
| CE-2 | CR-B | 112,279 | (774) | 8 | Fail |
| CE-3 | CR-C | 113,620 | (783.4) | 6 | Fail |

For Examples 5, 6, and 7, the epoxy resin compositions were formulated to provide a flexible cured composition. In Example 5, a monofunctional epoxy diluent was introduced into the composition which lowered crosslink density and increased flexibility. In Example 6, a more flexible epoxy was used; and in Example 7 a more flexible thiol was used. Comparative Examples 2 and 3 were formulated using a less flexible epoxy and a less flexible thiol. In addition, neither one contained a flexibilizing diluent (i.e., a monofunctional epoxy resin). Comparative Examples 2 and 3 failed the “Cylindrical Mandrel Bend” test due to cracking of the film on the surface of the silicone.

### Examples 8 and 9

Two-part, room temperature curing epoxy resin bonding compositions were prepared using the materials and amounts shown in Tables 6 and 7 and provided as Part A (Base component) and Part B (Accelerator component). The materials were added to a MAX 60 SPEEDMIXER cup from FlackTek, Inc. (Landrum, S.C.) and mixed at 1,500 rpm for one minute using a DAC 600 FVZ SPEEDMIXER from FlackTek, Inc. (Landrum, S.C.). The accelerator and base materials were both prepared separately.

TABLE 6
Base Component

Material (wt-%)

| Example | PY4122 | MX150 | Z6040 | CE10P |
|---|---|---|---|---|
| 8 | 65.0 | 18.5 | 2.8 | 13.7 |
| 9 | 65.0 | 18.5 | 2.8 | 13.7 |

TABLE 7
Accelerator Component

| | Material (wt-%) | | |
|---|---|---|---|
| Example | TMPMP | K54 | DBU |
| 8 | 96.5 | 3.5 | 0.0 |
| 9 | 96.5 | 0.0 | 3.5 |

The Base and Accelerator components were mixed in a 70:30/Base:Accelerator (w:w) ratio then knife coated onto the corona-treated surface of separate sheets of a silicone rubber substrate using the same procedure as described for Epoxy Resin Compositions A and C, and Comparative Epoxy Resin Composition A to prepare samples for peel adhesion strength testing using Silicone Rubber 1. Example 8 was cured 24 hours at room temperature to give a solid film which was then post-cured 30 minutes at 80° C., while Example 9 was cured for 24 hours at room temperature only. Peel adhesion strength, tensile properties, and crack resistance of the cured epoxy resin compositions were evaluated according to the “T-Peel Adhesion Strength,” “Tensile Modulus and Elongation,” and “Cylindrical Mandrel Bend” test methods described above. The results are shown in Tables 8 and 9 below. Both examples exhibited good bonding to the silicone substrates.

TABLE 8
Peel Adhesion Strength

| | | Toughening | Silicone | Silicone | Surface | Peel | | Failure |
|---|---|---|---|---|---|---|---|---|
| Ex. | Silane | Agent | Rubber | Cure Type | Treatment | oz/in. (N/dm) | | Mode |
| 8 | yes | yes | 1 | Platinum | Corona | 118.9 | (130.1) | Cohesive |
| 9 | yes | yes | 1 | Platinum | Corona | 73.7 | (80.7) | Cohesive |

TABLE 9
Tensile and Mandrel Bend Properties

| | Tensile Modulus | | Tensile Elongation | |
|---|---|---|---|---|
| Example | psi (MPa) | | (%) | Mandrel Test |
| 8 | 60.0 | (0.4) | 243 | Pass |
| 9 | 103.1 | (22) | 156 | Pass |

### Example 10

A pressure sensitive adhesive tape was prepared using an epoxy coated silicone rubber substrate in the following manner. The corona-treated surface of a sample of Silicone Rubber 1 substrate was coated with the Uncured Epoxy Resin Composition B (shown in Table 1) as described in the “T-Peel” test method with the following modification. After application, the coated silicone substrate was cured for one hour at 100° C. in an oven. Next, a piece of 91022 silicone adhesive transfer tape, measuring 1 inch wide by approximately 6 inches long (2.54 centimeters by 15.2 centimeters) was applied to the cured, exposed epoxy resin surface such that the adhesive was in contact with the epoxy. This was first rubbed down by hand at one end to initiate bonding. Then the remaining length was applied using a combination of hand pressure and small handheld rubber roller. A pressure sensitive adhesive tape construction having, in order, a silicone rubber substrate, a cured epoxy resin film, a pressure sensitive silicone adhesive, and release liner was thereby provided.

### Example 11

A pressure sensitive adhesive tape was prepared using a cured film derived from the Uncured Epoxy Resin Composition B (shown in Table 1) as follows. The Uncured Epoxy Resin Composition B was knife coated between two release liners to provide a nominal thickness of 0.012 inch (0.30 millimeters) then cured in an oven at 100° C. for one hour. The two release liners were removed to provide a cured film of epoxy resin. Next, a piece of 9472 acrylic adhesive transfer tape, measuring 1 inch wide by approximately 6 inches long (2.54 centimeters by 15.2 centimeters) was applied to the cured, exposed epoxy resin surface such that the adhesive was in contact with the epoxy. This was first rubbed down by hand at one end to initiate bonding. Then the remaining length was applied using a combination of hand pressure and small handheld rubber roller. A pressure sensitive adhesive tape construction having, in order, a cured epoxy resin film, an acrylic pressure sensitive adhesive, and a release liner was thereby provided.

The complete disclosures of the patents, patent documents, and publications cited herein are incorporated by reference in their entirety as if each were individually incorporated. To the extent that there is any conflict or discrepancy between this specification as written and the disclosure in any document that is incorporated by reference herein, this specification as written will control. Various modifications and alterations to this disclosure will become apparent to those skilled in the art without departing from the scope and spirit of this disclosure. It should be understood that this disclosure is not intended to be unduly limited by the illustrative embodiments and examples set forth herein and that such examples and embodiments are presented by way of example only with the scope of the disclosure intended to be limited only by the claims set forth herein as follows.

1. A curable epoxy/thiol resin composition comprising:
an epoxy resin component comprising an epoxy resin having at least two epoxide groups per molecule;
a thiol component comprising a polythiol compound having at least two primary thiol groups;
a silane-functionalized adhesion promoter having the following general Formula (II):
(X)ₘ—Y—(Si(R²)₃)ₙ
wherein: X is an epoxy or thiol group,
Y is an aliphatic group,
m and n are independently 1-3, and
each R² is independently an alkoxy group; and
a nitrogen-containing catalyst for curing the epoxy resin;
wherein the epoxy resin component and/or the thiol component are selected to provide a cured polymeric material that does not crack according to the Cylindrical Mandrel Bend Test and/or has a tensile elongation of at least 100% according to the Tensile Modulus and Elongation Test.

2. The curable epoxy/thiol resin composition of claim 1 which is a one-part composition.

3. The curable epoxy/thiol resin composition of claim 1 further comprising a cure inhibitor.

4. The curable epoxy/thiol resin composition of claim 3 wherein the cure inhibitor comprises a Lewis acid.

5. The curable epoxy/thiol resin composition of claim 4 wherein the Lewis acid cure inhibitor is selected from a borate ester, CaNO₃, MnNO₃, and a combination thereof.

6. The curable epoxy/thiol resin composition of claim 3 wherein the cure inhibitor comprises a weak Bronsted acid.

7. The curable epoxy/thiol resin composition of claim 6 wherein the weak Bronsted acid cure inhibitor is selected from a barbituric acid derivative, 1,3-cyclohexanedione, 2,2-dimethyl-1,3-dioxane-4,6-dione, and a combination thereof.

8. The curable epoxy/thiol resin composition of claim 1 which is a two-part composition comprising a base and an accelerator, wherein the base comprises the epoxy resin component and the silane-functionalized adhesion promoter, and the accelerator comprises the thiol component and the nitrogen-containing catalyst.

9. The curable epoxy/thiol resin composition of claim 1 wherein the epoxy resin comprises a polyglycidyl ether of a polyhydric phenol, a reaction product of a polyhydric alcohol with epichlorohydrin, an epoxidised (poly)olefinic resin, an epoxidised phenolic novolac resin, an epoxidised cresol novolac resin, a cycloaliphatic epoxy resin, a glycidyl ether ester, a polyglycidyl ester, a urethane modified epoxy resin, or a combination thereof.

10. The curable epoxy/thiol resin composition of claim 1 wherein the epoxy resin component is flexible.

11. The curable epoxy/thiol resin composition of claim 10 wherein the epoxy resin component comprises an epoxy compound having a linear or cyclic aliphatic structure, a diglycidyl ether of a polyether, a cashew nut oil or other natural oil, an alkyl-functionalized diglycidyl ether of Bisphenol A, an ethoxylated or propoxylated bisphenol A diglycidyl epoxy derivative, or a combination thereof.

12. The curable epoxy/thiol resin composition of claim 10 wherein the epoxy resin component comprises a monofunctional reactive diluent.

13. The curable epoxy/thiol resin composition of claim 1 wherein the epoxy resin component is present in an amount of 20 wt-% to 80 wt-%, based on the total weight of the curable epoxy/thiol resin composition.

14. The curable epoxy/thiol resin composition of claim 1 wherein the polythiol compound comprises trimethylolpropane tris(beta-mercaptopropionate), trimethylolpropane tris(thioglycolate), pentaerythritol tetrakis(thioglycolate), pentaerythritol tetrakis(beta-mercaptopropionate), dipentaerythritol poly(beta-mercaptopropionate), ethylene glycol bis(beta-mercaptopropionate), a (C1-C12)alkyl polythiol, a (C6-C12)aromatic polythiol, or a combination thereof.

15. The curable epoxy/thiol resin composition of claim 1 wherein the thiol component is flexible.

16. The curable epoxy/thiol resin composition of claim 1 wherein the thiol component is present in an amount of 25 wt-% to 70 wt-%, based on a total weight of the curable epoxy/thiol resin composition.

17. The curable epoxy/thiol resin composition of claim 1 wherein the epoxy resin component and the thiol component are present in a ratio of from 0.5:1 to 1.5:1 (epoxy:thiol equivalents).

18. The curable epoxy/thiol resin composition of claim 1 wherein the silane-functionalized adhesion promoter has the following general Formula (II):
(X)ₘ—Y—(Si(R²)₃)ₙ
wherein: X is an epoxy or thiol group,
Y is a (C2-C6)aliphatic group,
m and n are each 1, and
each R² is independently a methoxy or ethoxy group.

19-31. (canceled)

32. A silicone tape comprising:
a silicone backing having a major surface that is surface treated;
a tie layer disposed on the treated major surface of the silicone backing, wherein the tie layer comprises a cured polymeric material formed from a curable epoxy/thiol resin composition comprising:
an epoxy resin component comprising an epoxy resin having at least two epoxide groups per molecule;
a thiol component comprising a polythiol compound having at least two primary thiol groups;
a silane-functionalized adhesion promoter;
a nitrogen-containing catalyst for curing the epoxy resin component; and
an optional cure inhibitor; and
a pressure sensitive adhesive disposed on the tie layer.

33. The silicone tape of claim 32 wherein the epoxy resin component and/or the thiol component are selected to provide a cured polymeric material that does not crack according to the Cylindrical Mandrel Bend Test and/or has a tensile elongation of at least 100% according to the Tensile Modulus and Elongation Test.

34. (canceled)

35. (canceled)
